(19) United States
(12) Patent Application Publication
(10) Pub. No.: US 2012/0066138 A1
(43) Pub. Date: Mar. 15, 2012

(54) USER AFFINITY CONCENTRATIONS AS SOCIAL TOPOGRAPHY

(75) Inventors: Scott Curtis, Durham, NC (US); Kunal Kandekar, Jersey City, NJ (US)

(73) Assignee: Waldeck Technology, LLC, Wilmington, DE (US)

(21) Appl. No.: 12/860,252

(22) Filed: Aug. 20, 2010

Related U.S. Application Data
(60) Provisional application No. 61/236,296, filed on Aug. 24, 2009.

(51) Int. Cl. G06Q 99/00

(52) U.S. Cl. 705/319

(57) ABSTRACT

Systems and methods for generating a social topography map based on user affinity concentrations are disclosed. In general, locations and aggregate profiles are obtained for a number of crowds of users that are relevant to a geographic bounding region for a desired social topography map. Each aggregate profile includes information regarding an affinity between a corresponding crowd and a defined user profile. The defined user profile may be a user profile of a requesting user, or a select subset thereof, or a target user profile. Social topography data for the desired geographic bounding region is then generated based on the locations and aggregate profiles of the relevant crowds. The social topography data defines user affinity concentrations across the desired geographic bounding region. A social topography map may then be generated and presented to a requesting user based on the social topography data generated for the desired geographic bounding region.

### RELATED APPLICATIONS

This application claims the benefit of provisional patent application Ser. No. 61/236,296, filed Aug. 24, 2009, the disclosure of which is hereby incorporated herein by reference in its entirety.

### FIELD OF THE DISCLOSURE

The present disclosure relates to a topological map that is representative of user affinity concentrations for a corresponding geographic area.

### BACKGROUND

Oftentimes, users desire to know the affinity between themselves and other users in geographic area. One exemplary system for providing such information to a user is described in U.S. patent application Ser. No. 12/645,532, entitled FORMING CROWDS AND PROVIDING ACCESS TO CROWD DATA IN A MOBILE ENVIRONMENT, which was filed Dec. 23, 2009; U.S. patent application Ser. No. 12/645,539, entitled ANONYMOUS CROWD TRACKING, which was filed Dec. 23, 2009; U.S. patent application Ser. No. 12/645,535, entitled MAINTAINING A HISTORICAL RECORD OF ANONYMIZED USER PROFILE DATA BY LOCATION FOR USERS IN A MOBILE ENVIRONMENT, which was filed Dec. 23, 2009; U.S. patent application Ser. No. 12/645,546, entitled CROWD FORMATION FOR MOBILE DEVICE USERS, which was filed Dec. 23, 2009; U.S. patent application Ser. No. 12/645,556, entitled SERVING A REQUEST FOR DATA FROM A HISTORICAL RECORD OF ANONYMIZED USER PROFILE DATA IN A MOBILE ENVIRONMENT, which was filed Dec. 23, 2009; U.S. patent application Ser. No. 12/645,560, entitled HANDLING CROWD REQUESTS FOR LARGE GEOGRAPHIC AREAS, which was filed Dec. 23, 2009; and U.S. patent application Ser. No. 12/645,544, entitled MODIFYING A USER'S CONTRIBUTION TO AN AGGREGATE PROFILE BASED ON TIME BETWEEN LOCATION UPDATES AND EXTERNAL EVENTS, which was filed Dec. 23, 2009; all of which are commonly owned and assigned and are hereby incorporated herein by reference in their entireties. In this exemplary system, crowds of users are formed. Further, the locations of the crowds and affinity between a requesting user and the crowds may be presented to the requesting user via a map interface. However, as the number of crowds in a desired geographic area increases, the map interface may become increasingly cluttered. As such, there is a need for a system and method for generating and displaying user affinity concentrations and the volume of data to a user for a desired geographic area in a manner that is easily and quickly understandable by the user.

### SUMMARY

Systems and methods for generating a social topography map based on user affinity concentrations are disclosed. In general, locations and aggregate profiles are obtained for a number of crowds of users that are relevant to a geographic bounding region for a desired social topography map. Each aggregate profile includes information regarding an affinity between a corresponding crowd and a defined user profile. The defined user profile may be a user profile of a requesting user, or a select subset thereof, or a target user profile. Social topography data for the desired geographic bounding region is then generated based on the locations and aggregate profiles of the relevant crowds. The social topography data defines user affinity concentrations across the desired geographic bounding region. A social topography map may then be generated and presented to a requesting user based on the social topography data generated for the desired geographic bounding region.

In one embodiment, the social topography data for the desired geographic bounding region includes a user affinity distribution for the desired geographic bounding region. More specifically, in one embodiment, the desired geographic bounding region is divided into a number of sub-regions. For each sub-region of at least a subset of the sub-regions, the user affinity distribution includes a combined user affinity for one or more of the relevant crowds that are relevant to the sub-region. The combined user affinity is determined based on the user affinities included in the aggregate profiles of the one or more of the relevant crowds that are relevant to the sub-region.

In one embodiment, in addition to the user affinity distribution, the social topography data for the desired geographic region includes a user distribution for the desired geographic bounding region. More specifically, in one embodiment, the desired geographic bounding region is divided into a number of sub-regions. For each sub-region of at least a subset of the sub-regions, the user distribution includes a total number of users in one or more of the relevant crowds that are relevant to the sub-region or a total number of the relevant crowds that are relevant to the sub-region, depending on the particular embodiment.

In one embodiment, the social topography map is a 3-dimensional topography map where a height dimension of the 3-dimensional topography map is representative of user concentrations within the desired geographic bounding region and a second characteristic of the social topography map, such as but not limited to color or shading, is representative of user affinity or the volume of data. In another embodiment, the social topography map is a 3-dimensional topography map where the height dimension of the 3-dimensional topography map is representative of user affinity and a second characteristic of the social topography map, such as but not limited to color or shading, is representative of user concentrations.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a Mobile Aggregate Profile (MAP) system according to one embodiment of the present disclosure;

FIG. 2 is a block diagram of the MAP server of FIG. 1 according to one embodiment of the present disclosure;

FIG. 3 is a block diagram of the MAP client of one of the mobile devices of FIG. 1 according to one embodiment of the present disclosure;

FIG. 4 illustrates the operation of the system of FIG. 1 to provide user profiles and current locations of the users of the mobile devices to the MAP server according to one embodiment of the present disclosure;

FIG. 5 illustrates the operation of the system of FIG. 1 to provide user profiles and current locations of the users of the mobile devices to the MAP server according to another embodiment of the present disclosure;

FIGS. 6A through 6D illustrate a crowd formation process according to one embodiment of the present disclosure;

FIGS. 7A through 7D, 8A through 8F, and 9A through 9E graphically illustrate the crowd formation process of FIGS. 6A through 6D according to one embodiment of the present disclosure;

FIG. 10 illustrates an exemplary social topography map generated based on aggregate profiles of crowds located in a corresponding geographic bounding region according to one embodiment of the present disclosure;

FIG. 11 illustrates the operation of the system of FIG. 1 to generate a social topography map according to one embodiment of the present disclosure;

FIG. 12 is a more detailed illustration of a process for generating a social topography for a desired geographic bounding region according to one embodiment of the present disclosure;

FIG. 13 illustrates the operation of the system of FIG. 1 to generate a social topography map according to another embodiment of the present disclosure;

FIG. 14 is a block diagram of the MAP server of FIG. 1 according to one embodiment of the present disclosure;

FIG. 15 is a block diagram of one of the mobile devices of FIG. 1 according to one embodiment of the present disclosure;

FIG. 16 is a block diagram of the subscriber device of FIG. 1 according to one embodiment of the present disclosure; and

FIG. 17 is a block diagram of a computing device operating to host the third-party service of FIG. 1 according to one embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

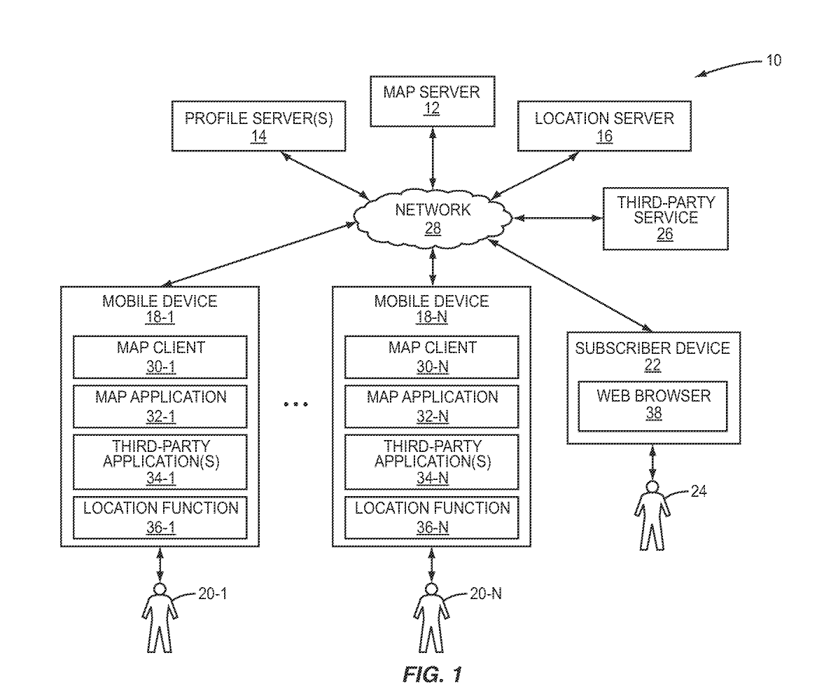

Systems and methods for generating a social topography map based on user affinity concentrations are disclosed. FIG. 1 illustrates a Mobile Aggregate Profile (MAP) system 10 in which social topography maps are generated based on user affinity concentrations according to one embodiment of the present disclosure. In this embodiment, the system 10 includes a MAP server 12, one or more profile servers 14, a location server 16, a number of mobile devices 18-1 through 18-N having associated users 20-1 through 20-N, a subscriber device 22 having an associated subscriber 24, and a third-party service 26 communicatively coupled via a network 28. The mobile devices 18-1 through 18-N are also generally referred to herein as mobile devices 18, and a single one of the mobile devices 18-1 through 18-N may also be referred to herein as a mobile device 18. Likewise, the users 20-1 through 20-N are also generally referred to herein as users 20, and a single one of the users 20-1 through 20-N is also generally referred to herein as a user 20. The network 28 may be any type of network or any combination of networks. Specifically, the network 28 may include wired components, wireless components, or both wired and wireless components. In one exemplary embodiment, the network 28 is a distributed public network such as the Internet, where the mobile devices 18 are enabled to connect to the network 28 via local wireless connections (e.g., WiFi or IEEE 802.11 connections) or wireless telecommunications connections (e.g., 3G or 4G telecommunications connections such as GSM, LTE, W-CDMA, or WiMAX connections).

As discussed below in detail, the MAP server 12 operates to obtain current locations, including location updates, and user profiles of the users 20 of the mobile devices 18. The current locations of the users 20 can be expressed as positional geographic coordinates such as latitude-longitude pairs, and a height vector (if applicable), or any other similar information capable of identifying a given physical point in space in a two-dimensional or three-dimensional coordinate system. Using the current locations and user profiles of the users 20, the MAP server 12 is enabled to provide a number of features such as, but not limited to, identifying crowds of users using current locations and/or user profiles of the users 20 and generating aggregate profiles for crowds of users using the user profiles of users in the crowds. While not essential, for additional information regarding exemplary operation of the MAP server 12, the interested reader is directed to U.S. patent application Ser. No. 12/645,532, entitled FORMING CROWDS AND PROVIDING ACCESS TO CROWD DATA IN A MOBILE ENVIRONMENT, which was filed Dec. 23, 2009; U.S. patent application Ser. No. 12/645,539, entitled ANONYMOUS CROWD TRACKING, which was filed Dec. 23, 2009; U.S. patent application Ser. No. 12/645,535, entitled MAINTAINING A HISTORICAL RECORD OF ANONYMIZED USER PROFILE DATA BY LOCATION FOR USERS IN A MOBILE ENVIRONMENT, which was filed Dec. 23, 2009; U.S. patent application Ser. No. 12/645,546, entitled CROWD FORMATION FOR MOBILE DEVICE USERS, which was filed Dec. 23, 2009; U.S. patent application Ser. No. 12/645,556, entitled SERVING A REQUEST FOR DATA FROM A HISTORICAL RECORD OF ANONYMIZED USER PROFILE DATA IN A MOBILE ENVIRONMENT, which was filed Dec. 23, 2009; U.S. patent application Ser. No. 12/645,560, entitled HANDLING CROWD REQUESTS FOR LARGE GEOGRAPHIC AREAS, which was filed Dec. 23, 2009; and U.S. patent application Ser. No. 12/645,544, entitled MODIFYING A USER'S CONTRIBUTION TO AN AGGREGATE PROFILE BASED ON TIME BETWEEN LOCATION UPDATES AND EXTERNAL EVENTS, which was filed Dec. 23, 2009; all of which are commonly owned and assigned and are incorporated herein by reference in their entireties.

As discussed below in detail, the locations and aggregate profiles of the crowds provided by the MAP server 12 are utilized to provide social topography maps. A social topography map is a map that is indicative of user affinity concentrations for a desired geographic area, which is referred to herein as a bounding region for the social topography map. Note that while the MAP server 12 is illustrated as a single server for simplicity and ease of discussion, it should be appreciated that the MAP server 12 may be implemented as a single physical server or multiple physical servers operating in a collaborative manner for purposes of redundancy and/or load sharing.

In general, the one or more profile servers 14 operate to store user profiles for a number of persons including the users 20 of the mobile devices 18. For example, the one or more profile servers 14 may be servers providing social network services such the Facebook® social networking service, the MySpace® social networking service, the LinkedIN® social networking service, or the like. As discussed below, using the one or more profile servers 14, the MAP server 12 is enabled to directly or indirectly obtain the user profiles of the users 20 of the mobile devices 18. The location server 16 generally operates to receive location updates from the mobile devices 18 and make the location updates available to entities such as, for instance, the MAP server 12. In one exemplary embodiment, the location server 16 is a server operating to provide Yahoo!'s FireEagle service.

The mobile devices 18 may be mobile smart phones, portable media player devices, mobile gaming devices, or the like. Some exemplary mobile devices that may be programmed or otherwise configured to operate as the mobile devices 18 are the Apple® iPhone, the Palm Pre®, the Samsung Rogue™, the Blackberry Storm™, the Motorola Droid or similar phone running Google's Android™ Operating System, an Apple® iPad, and the Apple® iPod Touch® device. However, this list of exemplary mobile devices is not exhaustive and is not intended to limit the scope of the present disclosure.

The mobile devices 18-1 through 18-N include MAP clients 30-1 through 30-N (generally referred to herein as MAP clients 30 or individually as MAP client 30), MAP applications 32-1 through 32-N (generally referred to herein as MAP applications 32 or individually as MAP application 32), third-party applications 34-1 through 34-N (generally referred to herein as third-party applications 34 or individually as third-party application 34), and location functions 36-1 through 36-N (generally referred to herein as location functions 36 or individually as location function 36), respectively. The MAP client 30 is preferably implemented in software. In general, in the preferred embodiment, the MAP client 30 is a middleware layer operating to interface an application layer (i.e., the MAP application 32 and the third-party applications 34) to the MAP server 12. More specifically, the MAP client 30 enables the MAP application 32 and the third-party applications 34 to request and receive data from the MAP server 12. In addition, the MAP client 30 enables applications, such as the MAP application 32 and the third-party applications 34, to access data from the MAP server 12.

The MAP application 32 is also preferably implemented in software. The MAP application 32 generally provides a user interface component between the user 20 and the MAP server 12. More specifically, among other things, the MAP application 32 enables the user 20 to initiate requests for crowd data and/or social topography from the MAP server 12 and presents corresponding data returned by the MAP server 12 to the user 20. The MAP application 32 also enables the user 20 to configure various settings. For example, the MAP application 32 may enable the user 20 to select a desired social networking service (e.g., Facebook®, MySpace®, LinkedIN®, etc.) from which to obtain the user profile of the user 20 and provide any necessary credentials (e.g., username and password) needed to access the user profile from the social networking service.

The third-party applications 34 are preferably implemented in software. The third-party applications 34 operate to access the MAP server 12 via the MAP client 30. The third-party applications 34 may utilize data obtained from the MAP server 12 in any desired manner. As an example, one of the third-party applications 34 may be a gaming application that utilizes crowd data to notify the user 20 of Points of Interest (POIs) or Areas of Interest (AOIs) where crowds of interest are currently located. It should be noted that while the MAP client 30 is illustrated as being separate from the MAP application 32 and the third-party applications 34, the present disclosure is not limited thereto. The functionality of the MAP client 30 may alternatively be incorporated into the MAP application 32 and the third-party applications 34.

The location function 36 may be implemented in hardware, software, or a combination thereof. In general, the location function 36 operates to determine or otherwise obtain the location of the mobile device 18. For example, the location function 36 may be or include a Global Positioning System (GPS) receiver.

The subscriber device 22 is a physical device such as a personal computer, a mobile computer (e.g., a notebook computer, a netbook computer, a tablet computer, etc.), a mobile smart phone, or the like. The subscriber 24 associated with the subscriber device 22 is a person or entity. In general, the subscriber device 22 enables the subscriber 24 to access the MAP server 12 via a web browser 38 to obtain various types of data, preferably for a fee. For example, the subscriber 24 may pay a fee to have access to crowd data such as aggregate profiles for crowds located at one or more POIs and/or located in one or more AOIs, pay a fee to track crowds, or the like. Note that the web browser 38 is exemplary. In another embodiment, the subscriber device 22 is enabled to access the MAP server 12 via a custom application.

Lastly, the third-party service 26 is a service that has access to data from the MAP server 12 such as aggregate profiles for one or more crowds at one or more POIs or within one or more AOIs. Based on the data from the MAP server 12, the third-party service 26 operates to provide a service such as, for example, targeted advertising. For example, the third-party service 26 may obtain anonymous aggregate profile data for one or more crowds located at a POI and then provide targeted advertising to known users located at the POI based on the anonymous aggregate profile data. Note that while targeted advertising is mentioned as an exemplary third-party service 26, other types of third-party services 26 may additionally or alternatively be provided. Other types of third-party services 26 that may be provided will be apparent to one of ordinary skill in the art upon reading this disclosure.

Before proceeding, it should be noted that while the system 10 of FIG. 1 illustrates an embodiment where the one or more profile servers 14 and the location server 16 are separate from the MAP server 12, the present disclosure is not limited thereto. In an alternative embodiment, the functionality of the one or more profile servers 14 and/or the location server 16 may be implemented within the MAP server 12.

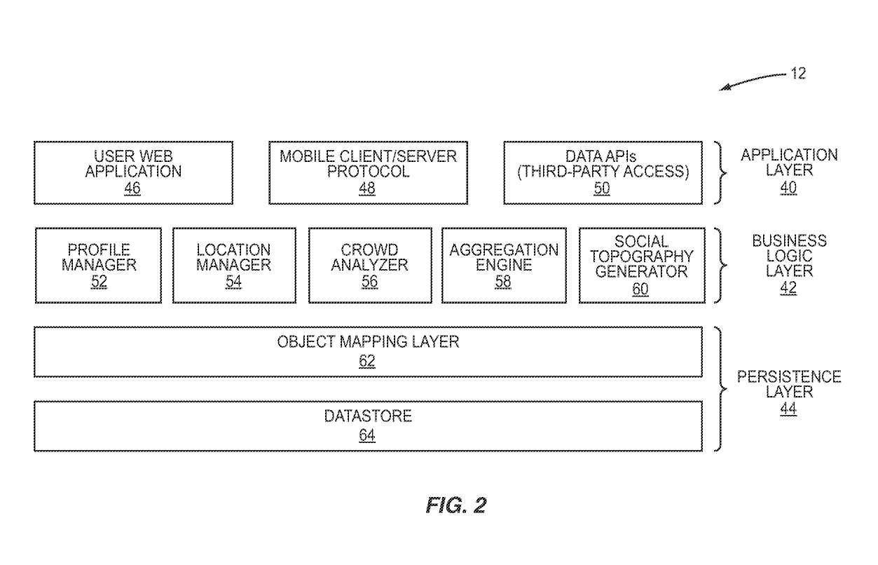

FIG. 2 is a block diagram of the MAP server 12 of FIG. 1 according to one embodiment of the present disclosure. As illustrated, the MAP server 12 includes an application layer 40, a business logic layer 42, and a persistence layer 44. The application layer 40 includes a user web application 46, a mobile client/server protocol component 48, and one or more data Application Programming Interfaces (APIs) 50. The user web application 46 is preferably implemented in software and operates to provide a web interface for users, such as the subscriber 24, to access the MAP server 12 via a web browser. The mobile client/server protocol component 48 is preferably implemented in software and operates to provide an interface between the MAP server 12 and the MAP clients 30-1 through 30-N hosted by the mobile devices 18-1 through 18-N. The data APIs 50 enable third-party services, such as the third-party service 26, to access the MAP server 12.

The business logic layer 42 includes a profile manager 52, a location manager 54, a crowd analyzer 56, an aggregation engine 58, and, in some embodiments, a social topography generator 60, each of which is preferably implemented in software. The profile manager 52 generally operates to obtain the user profiles of the users 20 and store the user profiles in the persistence layer 44. The location manager 54 operates to obtain the current locations of the users 20 including location updates. As discussed below, the current locations of the users 20 may be obtained directly from the mobile devices 18 and/or obtained from the location server 16. The crowd analyzer 56 operates to form crowds of users. In one embodiment, the crowd analyzer 56 utilizes a spatial crowd formation algorithm. However, the present disclosure is not limited thereto. The aggregation engine 58 generally operates to provide aggregate profile data for crowds of users. The social topography generator 60 operates to process social topography requests to generate corresponding social topography data based on crowds and user affinities of the crowds relevant to a corresponding geographic bounding region.

The persistence layer 44 includes an object mapping layer 62 and a datastore 64. The object mapping layer 62 is preferably implemented in software. The datastore 64 is preferably a relational database, which is implemented in a combination of hardware (i.e., physical data storage hardware) and software (i.e., relational database software). In this embodiment, the business logic layer 42 is implemented in an object-oriented programming language such as, for example, Java. As such, the object mapping layer 62 operates to map objects used in the business logic layer 42 to relational database entities stored in the datastore 64. Note that, in one embodiment, data is stored in the datastore 64 in a Resource Description Framework (RDF) compatible format.

In an alternative embodiment, rather than being a relational database, the datastore 64 may be implemented as an RDF datastore. More specifically, the RDF datastore may be compatible with RDF technology adopted by Semantic Web activities. Namely, the RDF datastore may use the Friend-Of-A-Friend (FOAF) vocabulary for describing people, their social networks, and their interests. In this embodiment, the MAP server 12 may be designed to accept raw FOAF files describing persons, their friends, and their interests. These FOAF files are currently output by some social networking services such as Livejournal and Facebook®. The MAP server 12 may then persist RDF descriptions of the users 20 as a proprietary extension of the FOAF vocabulary that includes additional properties desired for the system 10.

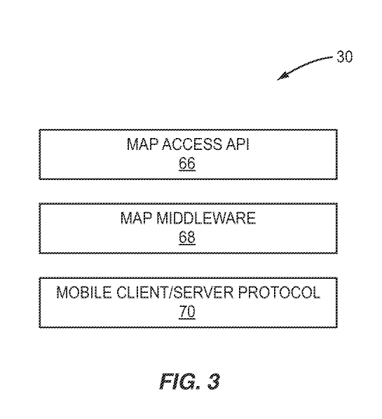

FIG. 3 illustrates the MAP client 30 of FIG. 1 in more detail according to one embodiment of the present disclosure. As illustrated, in this embodiment, the MAP client 30 includes a MAP access API 66, a MAP middleware component 68, and a mobile client/server protocol component 70. The MAP access API 66 is implemented in software and provides an interface by which the MAP client 30 and the third-party applications 34 are enabled to access the MAP client 30. The MAP middleware component 68 is implemented in software and performs the operations needed for the MAP client 30 to operate as an interface between the MAP application 32 and the third-party applications 34 at the mobile device 18 and the MAP server 12. The mobile client/server protocol component 70 enables communication between the MAP client 30 and the MAP server 12 via a defined protocol.

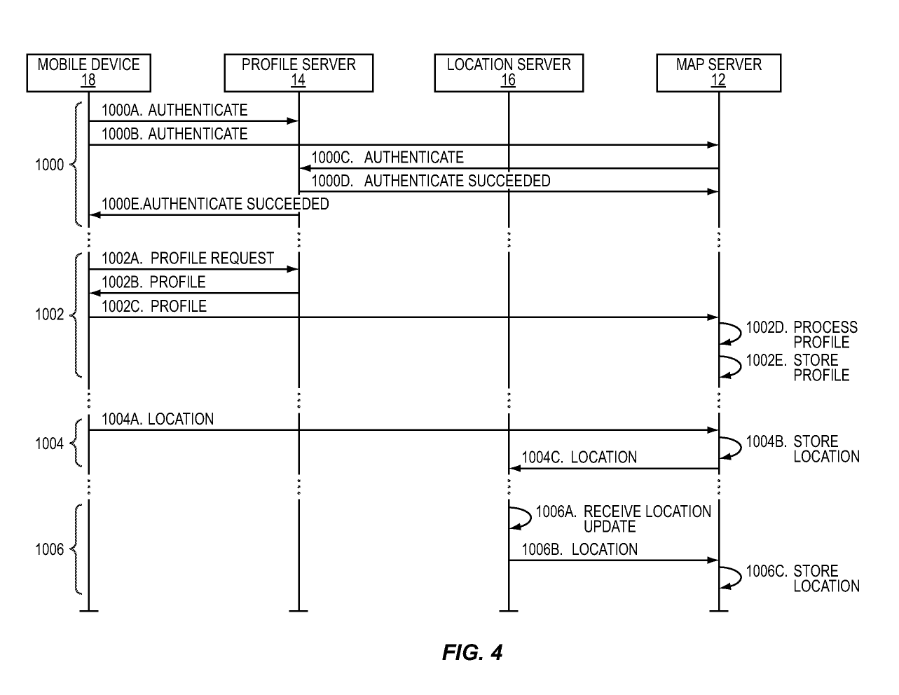

FIG. 4 illustrates the operation of the system 10 of FIG. 1 to provide the user profile of the one of the users 20 to the MAP server 12 according to one embodiment of the present disclosure. First, an authentication process is performed (step 1000). For authentication, in this embodiment, the mobile device 18 of the user 20 authenticates with the profile server 14 (step 1000A) and the MAP server 12 (step 1000B). In addition, the MAP server 12 authenticates with the profile server 14 (step 1000C). Preferably, authentication is preformed using OpenID or similar technology. However, authentication may alternatively be performed using separate credentials (e.g., username and password) of the user 20 for access to the MAP server 12 and the profile server 14. Assuming that authentication is successful, the profile server 14 returns an authentication succeeded message to the MAP server 12 (step 1000D), and the profile server 14 returns an authentication succeeded message to the MAP client 30 of the mobile device 18 (step 1000E).

At some point after authentication is complete, a user profile process is performed such that a user profile of the user 20 is obtained from the profile server 14 and delivered to the MAP server 12 (step 1002). In this embodiment, the MAP client 30 of the mobile device 18 sends a profile request to the profile server 14 (step 1002A). In response, the profile server 14 returns the user profile of the user 20 to the mobile device 18 (step 1002B). The MAP client 30 of the mobile device 18 then sends the user profile of the user 20 to the MAP server 12 (step 1002C). Note that while in this embodiment the MAP client 30 sends the complete user profile of the user 20 to the MAP server 12, in an alternative embodiment, the MAP client 30 may filter the user profile of the user 20 according to criteria specified by the user 20. For example, the user profile of the user 20 may include demographic information, general interests, music interests, and movie interests, and the user 20 may specify that the demographic information or some subset thereof is to be filtered, or removed, before sending the user profile to the MAP server 12.

Upon receiving the user profile of the user 20 from the MAP client 30 of the mobile device 18, the profile manager 52 of the MAP server 12 processes the user profile (step 1002D). More specifically, in the preferred embodiment, the profile manager 52 includes social network handlers for the social network services supported by the MAP server 12. Thus, for example, if the MAP server 12 supports user profiles from Facebook®, MySpace®, and LinkedIN®, the profile manager 52 may include a Facebook handler, a MySpace handler, and a LinkedIN handler. The social network handlers process user profiles to generate user profiles for the MAP server 12 that include lists of keywords for each of a number of profile categories. The profile categories may be the same for each of the social network handlers or different for each of the social network handlers. Thus, for this example assume that the user profile of the user 20 is from Facebook®. The profile manager 52 uses a Facebook handler to process the user profile of the user 20 to map the user profile of the user 20 from Facebook® to a user profile for the MAP server 12 including lists of keywords for a number of predefined profile categories. For example, for the Facebook handler, the profile categories may be a demographic profile category, a social interaction profile category, a general interests profile category, a music interests profile category, and a movie interests profile category. As such, the user profile of the user 20 from Facebook® may be processed by the Facebook handler of the profile manager 52 to create a list of keywords such as, for example, liberal, High School Graduate, 35-44, College Graduate, etc. for the demographic profile category; a list of keywords such as Seeking Friendship for the social interaction profile category; a list of keywords such as politics, technology, photography, books, etc. for the general interests profile category; a list of keywords including music genres, artist names, album names, or the like for the music interests profile category; and a list of keywords including movie titles, actor or actress names, director names, move genres, or the like for the movie interests profile category. In one embodiment, the profile manager 52 may use natural language processing or semantic analysis. For example, if the Facebook® user profile of the user 20 states that the user 20 is 20 years old, semantic analysis may result in the keyword of 18-24 years old being stored in the user profile of the user 20 for the MAP server 12.

After processing the user profile of the user 20, the profile manager 52 of the MAP server 12 stores the resulting user profile for the user 20 (step 1002E). More specifically, in one embodiment, the MAP server 12 stores user records for the users 20 in the datastore 64 (FIG. 2). The user profile of the user 20 is stored in the user record of the user 20. The user record of the user 20 includes a unique identifier of the user 20, the user profile of the user 20, and, as discussed below, a current location of the user 20. Note that the user profile of the user 20 may be updated as desired. For example, in one embodiment, the user profile of the user 20 is updated by repeating step 1002 each time the user 20 activates the MAP application 32.

Note that the while the discussion herein focuses on an embodiment where the user profiles of the users 20 are obtained from the one or more profile servers 14, the user profiles of the users 20 may be obtained in any desired manner. For example, in one alternative embodiment, the user 20 may identify one or more favorite websites. The profile manager 52 of the MAP server 12 may then crawl the one or more favorite websites of the user 20 to obtain keywords appearing in the one or more favorite websites of the user 20. These keywords may then be stored as the user profile of the user 20.

At some point, a process is performed such that a current location of the mobile device 18 and thus a current location of the user 20 is obtained by the MAP server 12 (step 1004). In this embodiment, the MAP application 32 of the mobile device 18 obtains the current location of the mobile device 18 from the location function 36 of the mobile device 18. The MAP application 32 then provides the current location of the mobile device 18 to the MAP client 30, and the MAP client 30 then provides the current location of the mobile device 18 to the MAP server 12 (step 1004A). Note that step 1004A may be repeated periodically or in response to a change in the current location of the mobile device 18 in order for the MAP application 32 to provide location updates for the user 20 to the MAP server 12.

In response to receiving the current location of the mobile device 18, the location manager 54 of the MAP server 12 stores the current location of the mobile device 18 as the current location of the user 20 (step 1004B). More specifically, in one embodiment, the current location of the user 20 is stored in the user record of the user 20 maintained in the datastore 64 of the MAP server 12. In the preferred embodiment, only the current location of the user 20 is stored in the user record of the user 20. In this manner, the MAP server 12 maintains privacy for the user 20 since the MAP server 12 does not maintain a historical record of the location of the user 20.

In addition to storing the current location of the user 20, the location manager 54 sends the current location of the user 20 to the location server 16 (step 1004C). In this embodiment, by providing location updates to the location server 16, the MAP server 12 in return receives location updates for the user 20 from the location server 16. This is particularly beneficial when the mobile device 18 does not permit background processes. For instance, when the MAP application 32 is not active, other applications running on the mobile device 18 (or some other device of the user 20) may directly or indirectly provide location updates to the location server 16 for the user 20. This is illustrated in step 1006 where the location server 16 receives a location update for the user 20 directly or indirectly from another application running on the mobile device 18 or an application running on another device of the user 20 (step 1006A). The location server 16 then provides the location update for the user 20 to the MAP server 12 (step 1006B). In response, the location manager 54 updates and stores the current location of the user 20 in the user record of the user 20 (step 1006C). In this manner, the MAP server 12 is enabled to obtain location updates for the user 20 even when the MAP application 32 is not active at the mobile device 18.

FIG. 5 illustrates the operation of the system 10 of FIG. 1 to provide the user profiles of one of the users to the MAP server 12 according to another embodiment of the present disclosure. First, an authentication process is performed (step 1100). For authentication, in this embodiment, the mobile device 18 of the user 20 authenticates with the MAP server 12 (step 1100A), and the MAP server 12 authenticates with the profile server 14 (step 1100B). Preferably, authentication is performed using OpenID or similar technology. However, authentication may alternatively be performed using separate credentials (e.g., username and password) of the user 20 for access to the MAP server 12 and the profile server 14. Assuming that authentication is successful, the profile server 14 returns an authentication succeeded message to the MAP server 12 (step 1100C), and the MAP server 12 returns an authentication succeeded message to the MAP client 30 of the mobile device 18 (step 1100D).

At some point after authentication is complete, a user profile process is performed such that a user profile of the user 20 is obtained from the profile server 14 and delivered to the MAP server 12 (step 1102). In this embodiment, the profile manager 52 of the MAP server 12 sends a profile request to the profile server 14 (step 1102A). In response, the profile server 14 returns the user profile of the user 20 to the profile manager 52 of the MAP server 12 (step 1102B). Note that while in this embodiment the profile server 14 returns the complete user profile of the user 20 to the MAP server 12, in an alternative embodiment, the profile server 14 may return a filtered version of the user profile of the user 20 to the MAP server 12. The profile server 14 may filter the user profile of the user 20 according to criteria specified by the user 20. For example, the user profile of the user 20 may include demographic information, general interests, music interests, and movie interests, and the user 20 may specify that the demographic information or some subset thereof is to be filtered, or removed, before sending the user profile to the MAP server 12.

Upon receiving the user profile of the user 20, the profile manager 52 of the MAP server 12 processes the user profile (step 1102C). More specifically, as discussed above, in the preferred embodiment, the profile manager 52 includes social network handlers for the social network services supported by the MAP server 12. The social network handlers process user profiles to generate user profiles for the MAP server 12 that include lists of keywords for each of a number of profile categories. The profile categories may be the same for each of the social network handlers or different for each of the social network handlers.

After processing the user profile of the user 20, the profile manager 52 of the MAP server 12 stores the resulting user profile for the user 20 (step 1102D). More specifically, in one embodiment, the MAP server 12 stores user records for the users 20 in the datastore 64 (FIG. 2). The user profile of the user 20 is stored in the user record of the user 20. The user record of the user 20 includes a unique identifier of the user 20, the user profile of the user 20, and, as discussed below, a current location of the user 20. Note that the user profile of the user 20 may be updated as desired. For example, in one embodiment, the user profile of the user 20 is updated by repeating step 1102 each time the user 20 activates the MAP application 32.

Note that the while the discussion herein focuses on an embodiment where the user profiles of the users 20 are obtained from the one or more profile servers 14, the user profiles of the users 20 may be obtained in any desired manner. For example, in one alternative embodiment, the user 20 may identify one or more favorite websites. The profile manager 52 of the MAP server 12 may then crawl the one or more favorite websites of the user 20 to obtain keywords appearing in the one or more favorite websites of the user 20. These keywords may then be stored as the user profile of the user 20.

At some point, a process is performed such that a current location of the mobile device 18 and thus a current location of the user 20 is obtained by the MAP server 12 (step 1104). In this embodiment, the MAP application 32 of the mobile device 18 obtains the current location of the mobile device 18 from the location function 36 of the mobile device 18. The MAP application 32 then provides the current location of the user 20 of the mobile device 18 to the location server 16 (step 1104A). Note that step 1104A may be repeated periodically or in response to changes in the location of the mobile device 18 in order to provide location updates for the user 20 to the MAP server 12. The location server 16 then provides the current location of the user 20 to the MAP server 12 (step 1104B). The location server 16 may provide the current location of the user 20 to the MAP server 12 automatically in response to receiving the current location of the user 20 from the mobile device 18 or in response to a request from the MAP server 12.

In response to receiving the current location of the mobile device 18, the location manager 54 of the MAP server 12 stores the current location of the mobile device 18 as the current location of the user 20 (step 1104C). More specifically, in one embodiment, the current location of the user 20 is stored in the user record of the user 20 maintained in the datastore 64 of the MAP server 12. Note that only the current location of the user 20 is stored in the user record of the user 20. In this manner, the MAP server 12 maintains privacy for the user 20 since the MAP server 12 does not maintain a historical record of the location of the user 20. As discussed below in detail, historical data maintained by the MAP server 12 is anonymized in order to maintain the privacy of the users 20 through 20-N.

As discussed above, the use of the location server 16 is particularly beneficial when the mobile device 18 does not permit background processes. In this case, other applications running on the mobile device 18 (or some other device of the user 20) may provide location updates to the location server 16 for the user 20 when the MAP application 32 is not active. This is illustrated in step 1106 where the location server 16 receives a location update for the user 20 from another application running on the mobile device 18 or an application running on another device of the user 20 (step 1106A). The location server 16 then provides the location update for the user 20 to the MAP server 12 (step 1106B). In response, the location manager 54 updates and stores the current location of the user 20 in the user record of the user 20 (step 1106C). In this manner, the MAP server 12 is enabled to obtain location updates for the user 20 even when the MAP application 32 is not active at the mobile device 18.

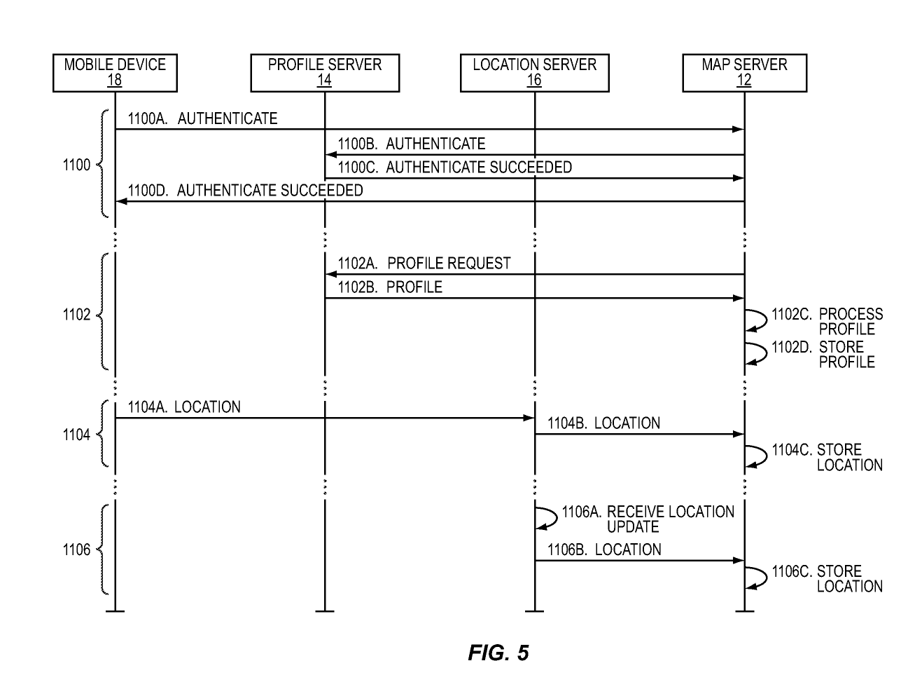

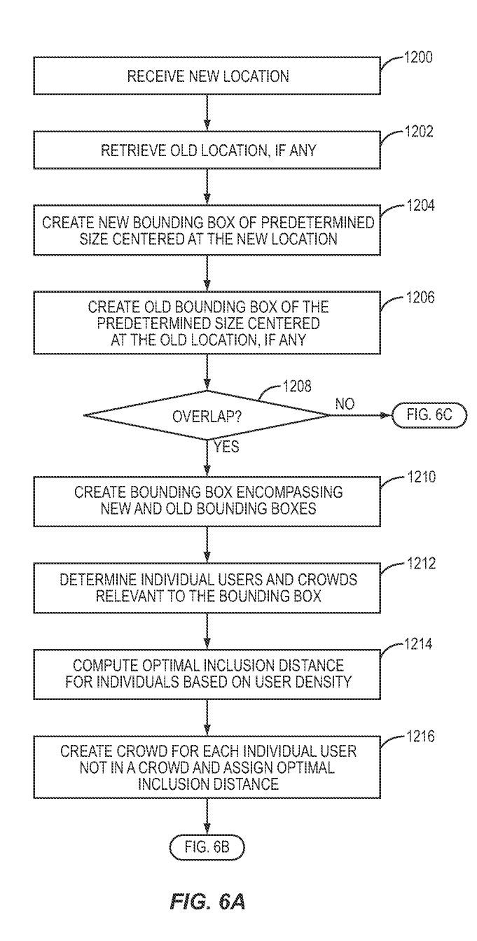

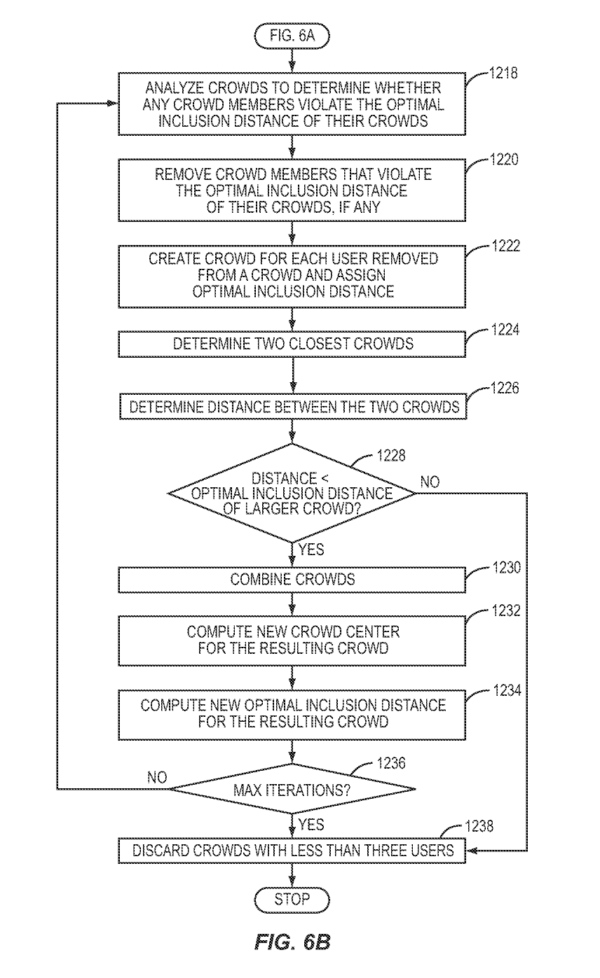

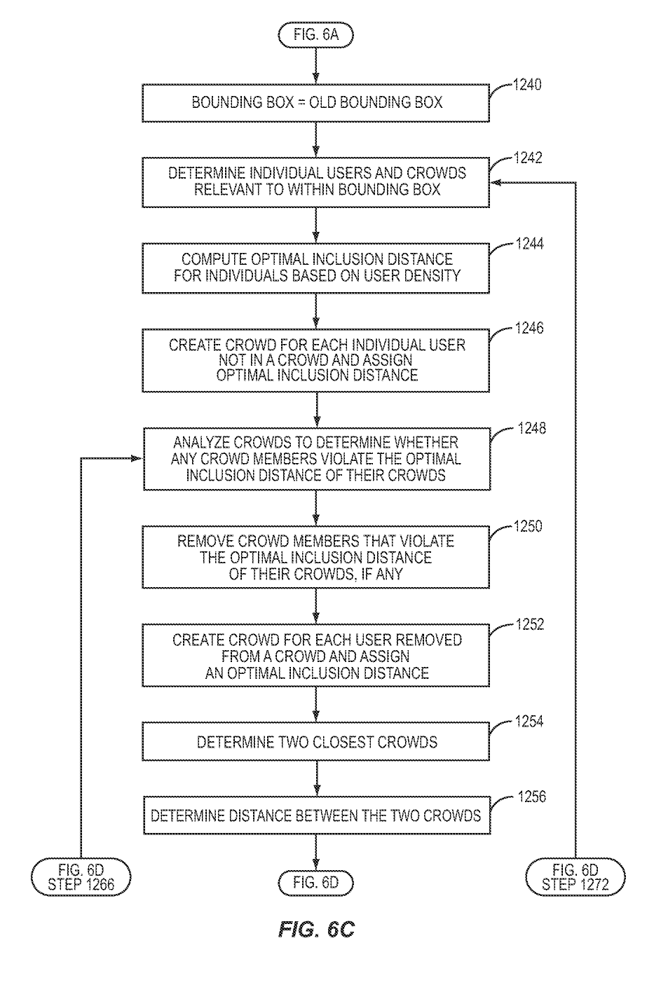

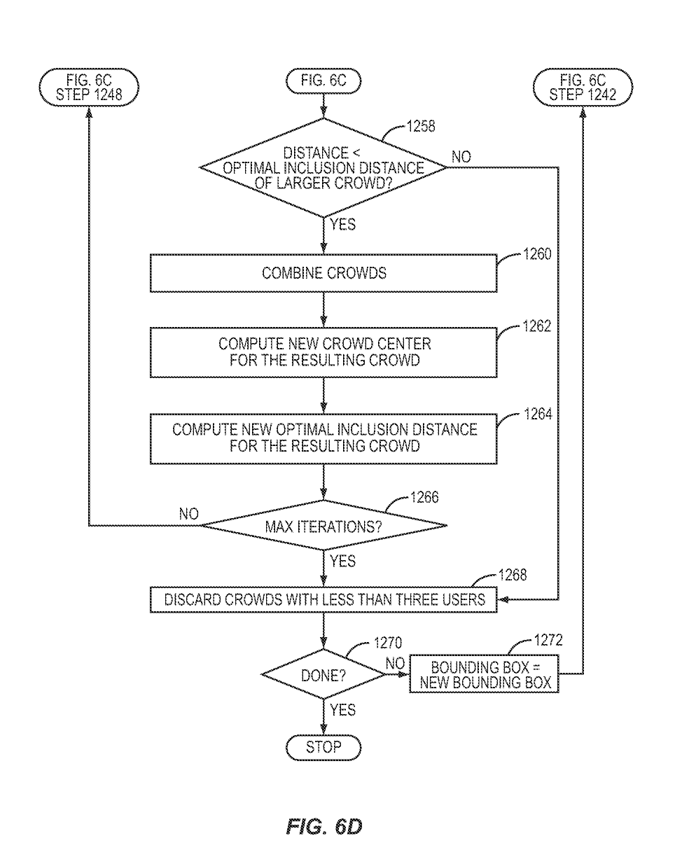

FIGS. 6A through 6D illustrate a spatial crowd formation process performed by the crowd analyzer 56 of the MAP server 12 according to one embodiment of the present disclosure. In this embodiment, the spatial crowd formation process is triggered in response to receiving a location update for one of the users 20 and is preferably repeated for each location update received for the users 20. As such, the crowd analyzer 56 first receives a location update, or a new location, for a user 20 (step 1200). In response, the crowd analyzer 56 retrieves an old location of the user 20, if any (step 1202). The old location is the current location of the user 20 prior to receiving the new location. The crowd analyzer 56 then creates a new bounding box of a predetermined size centered at the new location of the user 20 (step 1204) and an old bounding box of a predetermined size centered at the old location of the user 20, if any (step 1206). The predetermined size of the new and old bounding boxes may be any desired size. As one example, the predetermined size of the new and old bounding boxes is 40 meters by 40 meters. Note that if the user 20 does not have an old location (i.e., the location received in step 1200 is the first location received for the user 20), then the old bounding box is essentially null. Also note that while bounding “boxes” are used in this example, the bounding areas may be of any desired shape.

Next, the crowd analyzer 56 determines whether the new and old bounding boxes overlap (step 1208). If so, the crowd analyzer 56 creates a bounding box encompassing the new and old bounding boxes (step 1210). For example, if the new and old bounding boxes are 40×40 meter regions and a 1×1 meter square at the northeast corner of the new bounding box overlaps a 1×1 meter square at the southwest corner of the old bounding box, the crowd analyzer 56 may create a 79×79 meter square bounding box encompassing both the new and old bounding boxes.

The crowd analyzer 56 then determines the individual users and crowds relevant to the bounding box created in step 1210 (step 1212). The crowds relevant to the bounding box are crowds that are within or overlap the bounding box (e.g., have at least one user located within the bounding box). The individual users relevant to the bounding box are users that are currently located within the bounding box and not already part of a crowd. Next, the crowd analyzer 56 computes an optimal inclusion distance for individual users based on user density within the bounding box (step 1214). More specifically, in one embodiment, the optimal inclusion distance for individuals, which is also referred to herein as an initial optimal inclusion distance, is set according to the following equation:

$$initial\_optimal \_inclusion \_dist = a \cdot \sqrt{\frac{{A}_{BoundingBox}}{number\_of \_users}} ,$$

where a is a number between 0 and 1, A_{BoundingBox} is an area of the bounding box, and number of users is the total number of users in the bounding box. The total number of users in the bounding box includes both individual users that are not already in a crowd and users that are already in a crowd. In one embodiment, a is ⅔.

The crowd analyzer 56 then creates a crowd for each individual user within the bounding box that is not already included in a crowd and sets the optimal inclusion distance for the crowds to the initial optimal inclusion distance (step 1216). At this point, the process proceeds to FIG. 6B where the crowd analyzer 56 analyzes the crowds relevant to the bounding box to determine whether any of the crowd members (i.e., users in the crowds) violate the optimal inclusion distance of their crowds (step 1218). Any crowd member that violates the optimal inclusion distance of his or her crowd is then removed from that crowd (step 1220). The crowd analyzer 56 then creates a crowd of one user for each of the users removed from their crowds in step 1220 and sets the optimal inclusion distance for the newly created crowds to the initial optimal inclusion distance (step 1222).

Next, the crowd analyzer 56 determines the two closest crowds for the bounding box (step 1224) and a distance between the two closest crowds (step 1226). The distance between the two closest crowds is the distance between the crowd centers of the two closest crowds. The crowd analyzer 56 then determines whether the distance between the two closest crowds is less than the optimal inclusion distance of a larger of the two closest crowds (step 1228). If the two closest crowds are of the same size (i.e., have the same number of users), then the optimal inclusion distance of either of the two closest crowds may be used. Alternatively, if the two closest crowds are of the same size, the optimal inclusion distances of both of the two closest crowds may be used such that the crowd analyzer 56 determines whether the distance between the two closest crowds is less than the optimal inclusion distances of both of the two closest crowds. As another alternative, if the two closest crowds are of the same size, the crowd analyzer 56 may compare the distance between the two closest crowds to an average of the optimal inclusion distances of the two closest crowds.

If the distance between the two closest crowds is less than the optimal inclusion distance, the two closest crowds are combined or merged (step 1230), and a new crowd center for the resulting crowd is computed (step 1232). Again, a center of mass algorithm may be used to compute the crowd center of a crowd. In addition, a new optimal inclusion distance for the resulting crowd is computed (step 1234). In one embodiment, the new optimal inclusion distance for the resulting crowd is computed as:

$$average = \frac{1}{n + 1} \cdot ( initial\_optimal \_inclusion \_dist + {\sum }_{i = 1}^{n} {d}_{i} ) , \\ optimal\_inclusion \_dist = average + \sqrt{( \frac{1}{n} \cdot {\sum }_{i = 1}^{n} {( {d}_{i} - average )}^{2} )} ,$$

where n is the number of users in the crowd and dᵢ is a distance between the ith user and the crowd center. In other words, the new optimal inclusion distance is computed as the average of the initial optimal inclusion distance and the distances between the users in the crowd and the crowd center plus one standard deviation.

At this point, the crowd analyzer 56 determines whether a maximum number of iterations have been performed (step 1236). The maximum number of iterations is a predefined number that ensures that the crowd formation process does not indefinitely loop over steps 1218 through 1234 or loop over steps 1218 through 1234 more than a desired maximum number of times. If the maximum number of iterations has not been reached, the process returns to step 1218 and is repeated until either the distance between the two closest crowds is not less than the optimal inclusion distance of the larger crowd or the maximum number of iterations has been reached. At that point, the crowd analyzer 56 discards crowds with less than three users, or members, (step 1238) and the process ends.

Returning to step 1208 in FIG. 6A, if the new and old bounding boxes do not overlap, the process proceeds to FIG. 6C and the bounding box to be processed is set to the old bounding box (step 1240). In general, the crowd analyzer 56 then processes the old bounding box in much the same manner as described above with respect to steps 1212 through 1238. More specifically, the crowd analyzer 56 determines the individual users and crowds relevant to the bounding box (step 1242). The crowds relevant to the bounding box are crowds that are within or overlap the bounding box (e.g., have at least one user located within the bounding box). The individual users relevant to the bounding box are users that are currently located within the bounding box and not already part of a crowd. Next, the crowd analyzer 56 computes an optimal inclusion distance for individual users based on user density within the bounding box (step 1244). More specifically, in one embodiment, the optimal inclusion distance for individuals, which is also referred to herein as an initial optimal inclusion distance, is set according to the following equation:

$$initial\_optimal \_inclusion \_dist = a \cdot \sqrt{\frac{{A}_{BoundingBox}}{number\_of \_users}} ,$$

where a is a number between 0 and 1, A_{BoundingBox} is an area of the bounding box, and number_of_users is the total number of users in the bounding box. The total number of users in the bounding box includes both individual users that are not already in a crowd and users that are already in a crowd. In one embodiment, a is ⅔.

The crowd analyzer 56 then creates a crowd of one user for each individual user within the bounding box that is not already included in a crowd and sets the optimal inclusion distance for the crowds to the initial optimal inclusion distance (step 1246). At this point, the crowd analyzer 56 analyzes the crowds for the bounding box to determine whether any crowd members (i.e., users in the crowds) violate the optimal inclusion distance of their crowds (step 1248). Any crowd member that violates the optimal inclusion distance of his or her crowd is then removed from that crowd (step 1250). The crowd analyzer 56 then creates a crowd of one user for each of the users removed from their crowds in step 1250 and sets the optimal inclusion distance for the newly created crowds to the initial optimal inclusion distance (step 1252).

Next, the crowd analyzer 56 determines the two closest crowds in the bounding box (step 1254) and a distance between the two closest crowds (step 1256). The distance between the two closest crowds is the distance between the crowd centers of the two closest crowds. The crowd analyzer 56 then determines whether the distance between the two closest crowds is less than the optimal inclusion distance of a larger of the two closest crowds (step 1258). If the two closest crowds are of the same size (i.e., have the same number of users), then the optimal inclusion distance of either of the two closest crowds may be used. Alternatively, if the two closest crowds are of the same size, the optimal inclusion distances of both of the two closest crowds may be used such that the crowd analyzer 56 determines whether the distance between the two closest crowds is less than the optimal inclusion distances of both of the two closest crowds. As another alternative, if the two closest crowds are of the same size, the crowd analyzer 56 may compare the distance between the two closest crowds to an average of the optimal inclusion distances of the two closest crowds.

If the distance between the two closest crowds is less than the optimal inclusion distance, the two closest crowds are combined or merged (step 1260), and a new crowd center for the resulting crowd is computed (step 1262). Again, a center of mass algorithm may be used to compute the crowd center of a crowd. In addition, a new optimal inclusion distance for the resulting crowd is computed (step 1264). As discussed above, in one embodiment, the new optimal inclusion distance for the resulting crowd is computed as:

$$average = \frac{1}{n + 1} \cdot ( initial\_optimal \_inclusion \_dist + {\sum }_{i = 1}^{n} {d}_{i} ) , \\ optimal\_inclusion \_dist = average + \sqrt{( \frac{1}{n} \cdot {\sum }_{i = 1}^{n} {( {d}_{i} - average )}^{2} )} ,$$

where n is the number of users in the crowd and dᵢ is a distance between the ith user and the crowd center. In other words, the new optimal inclusion distance is computed as the average of the initial optimal inclusion distance and the distances between the users in the crowd and the crowd center plus one standard deviation.

At this point, the crowd analyzer 56 determines whether a maximum number of iterations have been performed (step 1266). If the maximum number of iterations has not been reached, the process returns to step 1248 and is repeated until either the distance between the two closest crowds is not less than the optimal inclusion distance of the larger crowd or the maximum number of iterations has been reached. At that point, the crowd analyzer 56 discards crowds with less than three users, or members (step 1268). Note that in the preferred embodiment, crowds are limited to three or more users. However, the present disclosure is not limited thereto. A crowd may be any number of two or more users. The crowd analyzer 56 then determines whether the crowd formation process for the new and old bounding boxes is done (step 1270). In other words, the crowd analyzer 56 determines whether both the new and old bounding boxes have been processed. If not, the bounding box is set to the new bounding box (step 1272), and the process returns to step 1242 and is repeated for the new bounding box. Once both the new and old bounding box have been processed, the crowd formation process ends.

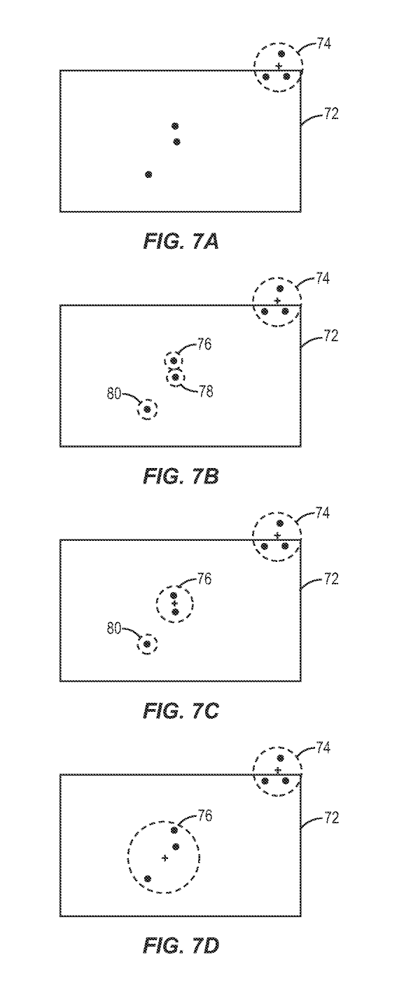

FIGS. 7A through 7D graphically illustrate the crowd formation process of FIGS. 6A through 6D for a scenario where the crowd formation process is triggered by a location update for a user having no old location. In this scenario, the crowd analyzer 56 creates a new bounding box 72 for the new location of the user, and the new bounding box 72 is set as the bounding box to be processed for crowd formation. Then, as illustrated in FIG. 7A, the crowd analyzer 56 identifies all individual users currently located within the bounding box 72 and all crowds located within or overlapping the bounding box. In this example, crowd 74 is an existing crowd relevant to the bounding box 72. Crowds are indicated by dashed circles, crowd centers are indicated by cross-hairs (+), and users are indicated as dots. Next, as illustrated in FIG. 7B, the crowd analyzer 56 creates crowds 76 through 80 of one user for the individual users, and the optional inclusion distances of the crowds 76 through 80 are set to the initial optimal inclusion distance. As discussed above, the initial optimal inclusion distance is computed by the crowd analyzer 56 based on a density of users within the bounding box 72.

The crowd analyzer 56 then identifies the two closest crowds 76 and 78 in the bounding box 72 and determines a distance between the two closest crowds 76 and 78. In this example, the distance between the two closest crowds 76 and 78 is less than the optimal inclusion distance. As such, the two closest crowds 76 and 78 are merged and a new crowd center and new optimal inclusion distance are computed, as illustrated in FIG. 7C. The crowd analyzer 56 then repeats the process such that the two closest crowds 76 and 80 in the bounding box 72 are again merged, as illustrated in FIG. 7D. At this point, the distance between the two closest crowds 74 and 76 is greater than the appropriate optimal inclusion distance. As such, the crowd formation process is complete.

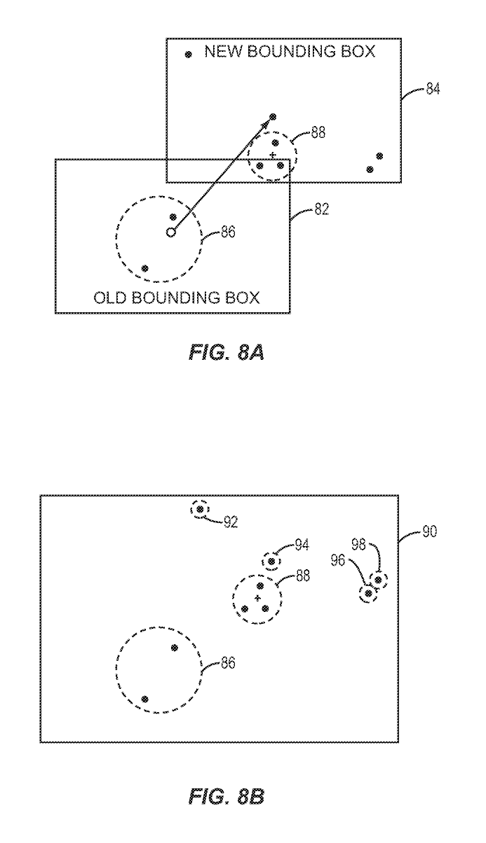

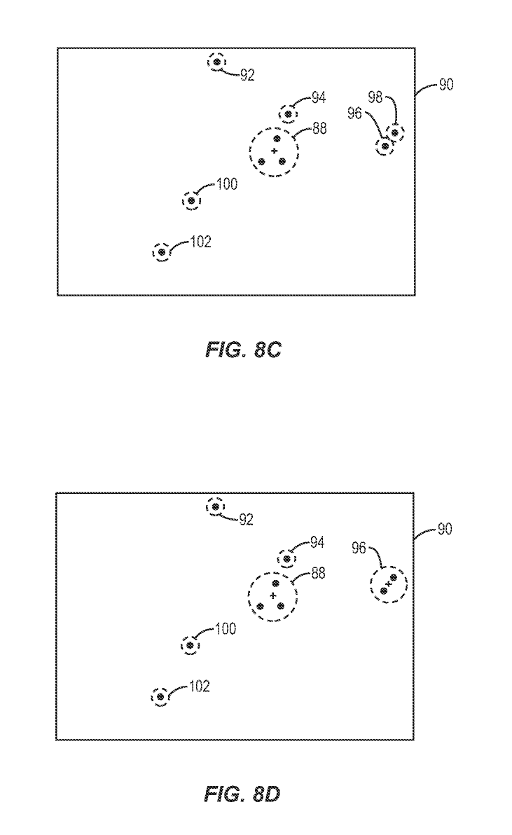

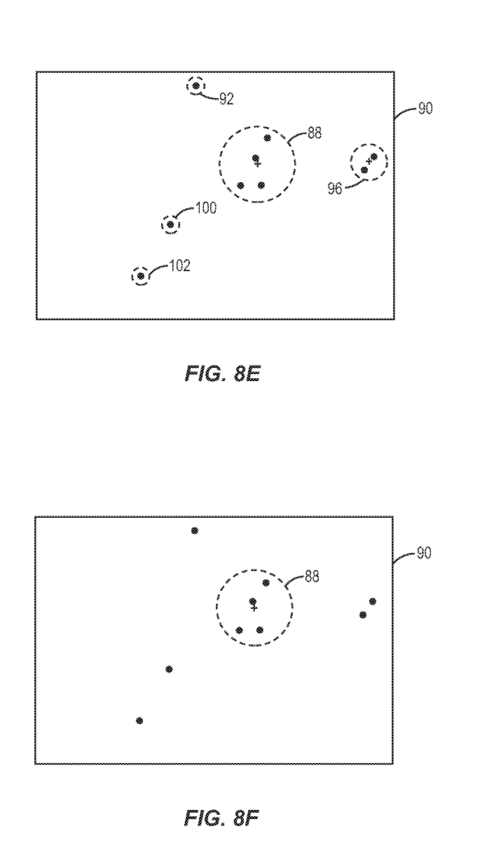

FIGS. 8A through 8F graphically illustrate the crowd formation process of FIGS. 6A through 6D for a scenario where the new and old bounding boxes overlap. As illustrated in FIG. 8A, a user moves from an old location to a new location, as indicated by an arrow. The crowd analyzer 56 receives a location update for the user giving the new location of the user. In response, the crowd analyzer 56 creates an old bounding box 82 for the old location of the user and a new bounding box 84 for the new location of the user. Crowd 86 exists in the old bounding box 82, and crowd 88 exists in the new bounding box 84.

Since the old bounding box 82 and the new bounding box 84 overlap, the crowd analyzer 56 creates a bounding box 90 that encompasses both the old bounding box 82 and the new bounding box 84, as illustrated in FIG. 8B. In addition, the crowd analyzer 56 creates crowds 92 through 98 for individual users currently located within the bounding box 90. The optimal inclusion distances of the crowds 92 through 98 are set to the initial optimal inclusion distance computed by the crowd analyzer 56 based on the density of users in the bounding box 90.

Next, the crowd analyzer 56 analyzes the crowds 86, 88, and 92 through 98 to determine whether any members of the crowds 86, 88, and 92 through 98 violate the optimal inclusion distances of the crowds 86, 88, and 92 through 98. In this example, as a result of the user leaving the crowd 86 and moving to his new location, both of the remaining members of the crowd 86 violate the optimal inclusion distance of the crowd 86. As such, the crowd analyzer 56 removes the remaining users from the crowd 86 and creates crowds 100 and 102 of one user each for those users, as illustrated in FIG. 8C.

The crowd analyzer 56 then identifies the two closest crowds in the bounding box 90, which in this example are the crowds 96 and 98. Next, the crowd analyzer 56 computes a distance between the two crowds 96 and 98. In this example, the distance between the two crowds 96 and 98 is less than the initial optimal inclusion distance and, as such, the two crowds 96 and 98 are combined. In this example, crowds are combined by merging the smaller crowd into the larger crowd. Since the two crowds 96 and 98 are of the same size, the crowd analyzer 56 merges the crowd 98 into the crowd 96, as illustrated in FIG. 8D. A new crowd center and new optimal inclusion distance are then computed for the crowd 96.

At this point, the crowd analyzer 56 repeats the process and determines that the crowds 88 and 94 are now the two closest crowds. In this example, the distance between the two crowds 88 and 94 is less than the optimal inclusion distance of the larger of the two crowds 88 and 94, which is the crowd 88. As such, the crowd 94 is merged into the crowd 88 and a new crowd center and optimal inclusion distance are computed for the crowd 88, as illustrated in FIG. 8E. At this point, there are no two crowds closer than the optimal inclusion distance of the larger of the two crowds. As such, the crowd analyzer 56 discards any crowds having less than three members, as illustrated in FIG. 8F. In this example, the crowds 92, 96, 100, and 102 have less than three members and are therefore removed. The crowd 88 has three or more members and, as such, is not removed. At this point, the crowd formation process is complete.

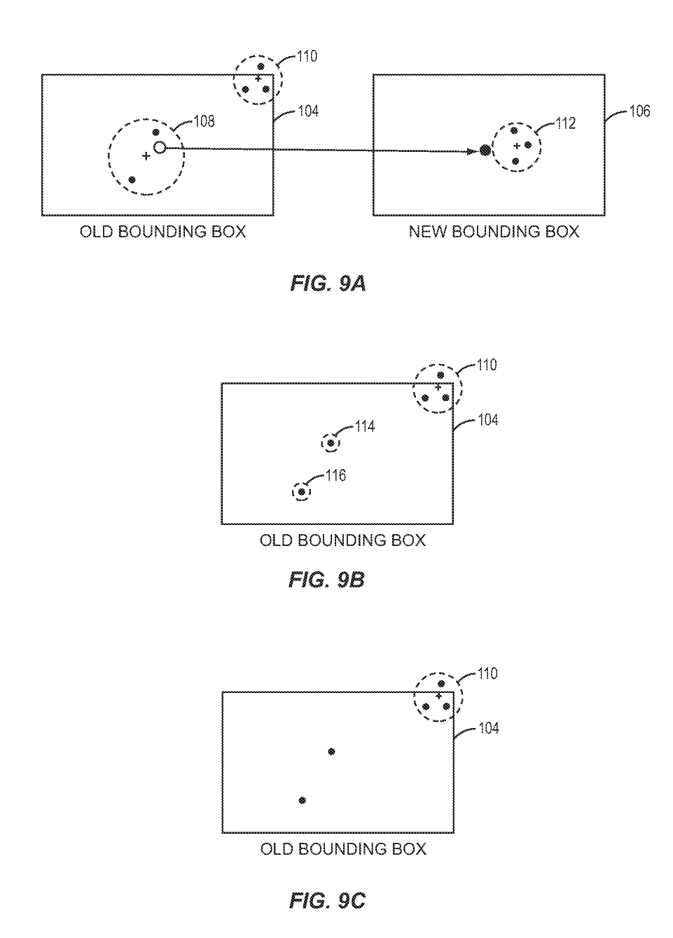

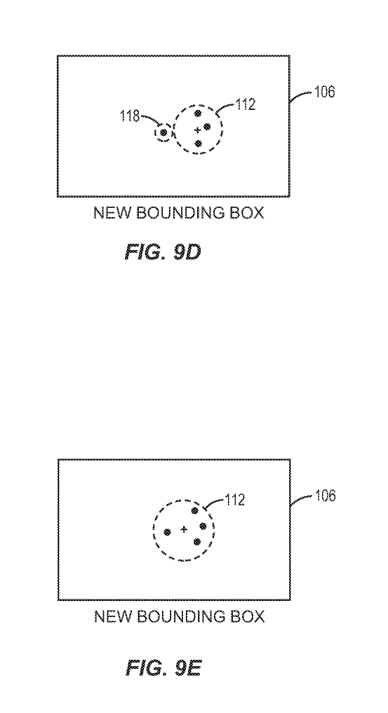

FIGS. 9A through 9E graphically illustrate the crowd formation process of FIGS. 6A through 6D in a scenario where the new and old bounding boxes do not overlap. As illustrated in FIG. 9A, in this example, the user moves from an old location to a new location. The crowd analyzer 56 creates an old bounding box 104 for the old location of the user and a new bounding box 106 for the new location of the user. Crowds 108 and 110 exist in the old bounding box 104, and crowd 112 exists in the new bounding box 106. In this example, since the old and new bounding boxes 104 and 106 do not overlap, the crowd analyzer 56 processes the old and new bounding boxes 104 and 106 separately.

More specifically, as illustrated in FIG. 9B, as a result of the movement of the user from the old location to the new location, the remaining users in the crowd 108 no longer satisfy the optimal inclusion distance for the crowd 108. As such, the remaining users in the crowd 108 are removed from the crowd 108, and crowds 114 and 116 of one user each are created for the removed users. In this example, no two crowds in the old bounding box 104 are close enough to be combined. As such, processing of the old bounding box 104 is complete as illustrated in FIG. 9C, and the crowd analyzer 56 proceeds to process the new bounding box 106.

As illustrated in FIG. 9D, processing of the new bounding box 106 begins by the crowd analyzer 56 creating a crowd 118 of one user for the user. The crowd analyzer 56 then identifies the crowds 112 and 118 as the two closest crowds in the new bounding box 106 and determines a distance between the two crowds 112 and 118. In this example, the distance between the two crowds 112 and 118 is less than the optimal inclusion distance of the larger crowd, which is the crowd 112. As such, the crowd analyzer 56 combines the crowds 112 and 118 by merging the crowd 118 into the crowd 112, as illustrated in FIG. 9E. A new crowd center and new optimal inclusion distance are then computed for the crowd 112. At this point, the crowd formation process is complete.

Before proceeding, it should be noted that the crowd formation process of FIGS. 6A through 6D, which has been graphically illustrated in FIGS. 7A through 7D, FIGS. 8A through 8F, and FIGS. 9A through 9E, is exemplary. Other crowd formation processes may be used as will be appreciated by one of ordinary skill in the art upon reading this disclosure.

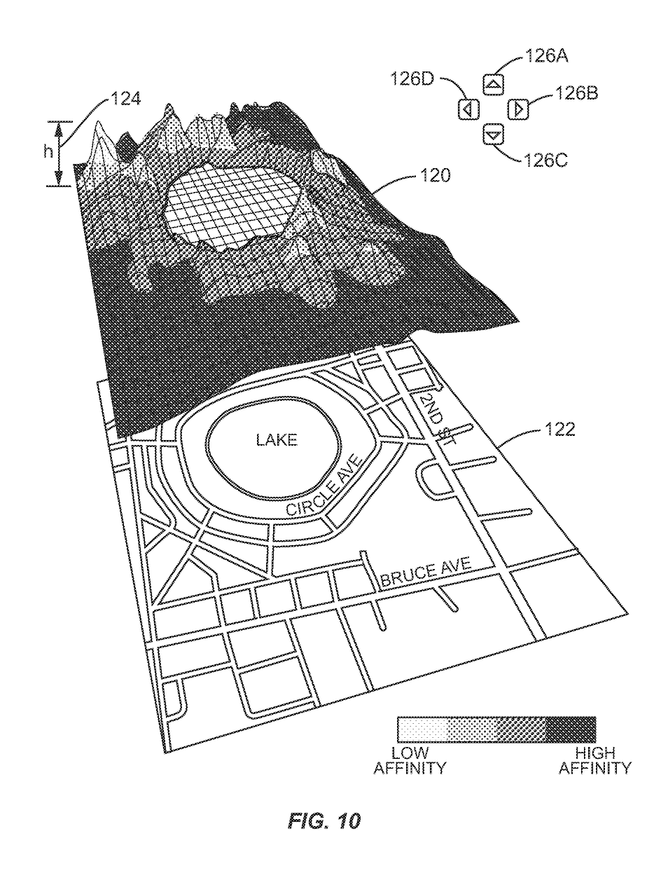

Crowds formed by a crowd formation process such as, but not limited to, the crowd formation process described above are utilized to provide social topography maps for desired geographic areas. Preferably, the social topography maps are generated as overlays that are overlaid upon maps of the corresponding geographic areas for which the social topography maps are generated. FIG. 10 illustrates an exemplary social topography map 120 according to one embodiment of the present disclosure. As illustrated, the social topography map 120 is a 3-dimensional (3D) topography map that is overlaid upon a map 122 of a geographic area for which the social topography map 120 was generated (i.e., the bounding region for the social topography map 120). The social topography map 120 is representative of user affinity concentrations within the geographic area represented by the map 122. In this embodiment, a height dimension 124 of the social topography map 120 represents user concentrations within the map 122, where the user concentrations are total number of users 20 by location or alternatively total number of crowds by location within the map 122. In addition, a shading of the social topography map 122 represents user affinity between users, or more specifically the crowds of users, by location within the map 122 and either a user profile of a requesting user or a target user profile defined by a requestor for whom the social topography map 120 is generated. While shading is used in this embodiment to represent user affinity, other characteristics of the social topography map 120 may alternatively be used such as, for example, color.

As illustrated, rotation controls 126A through 126D may enable a viewer to rotate the maps 120 and 122. In one embodiment, if the social topography map is displayed on a touch screen-enabled device, the user may rotate the maps using touch gestures instead of using the rotation controls 126A through 126D. In one embodiment, as the viewer rotates the maps 120 and 122 such that the maps 120 and 122 are viewed from above, the social topography map 120 may be converted from a 3D overlay to a 2-dimensional (2D) overlay. When presented as a 2D overlay, traditional topography map techniques may be used to represent the height dimension 124 of the social topography map 120. While not illustrated, the viewer may also be enabled to adjust other characteristics of the social topography map 120 such as, for example, opacity. The user may also be enabled to influence the affinity levels, the profile matching, and the crowd formation process itself, e.g., by manipulating a matching threshold which crowds must meet to be considered relevant.

It should be noted that the social topography map 120 of FIG. 10 is exemplary. Numerous variations will be appreciated by one of ordinary skill in the art upon reading this disclosure and such variations are to be considered within the scope of the present disclosure. For example, in another embodiment, the height dimension 124 of the social topography map 120 may represent user affinity and another characteristic (e.g., shading or color) may represent user concentrations. As another example, icons or other indicators may be presented as overlays on the map 122, where the type of icon/indicator may represent user affinity and a size of the icons represent user concentrations. For example, happy faces may be overlaid upon locations in the map 122 where there is high user affinity and the sizes of those happy faces is controlled to represent the total number of users or crowds at those locations. Similarly, sad faces may be used to shows locations that have low user affinities.

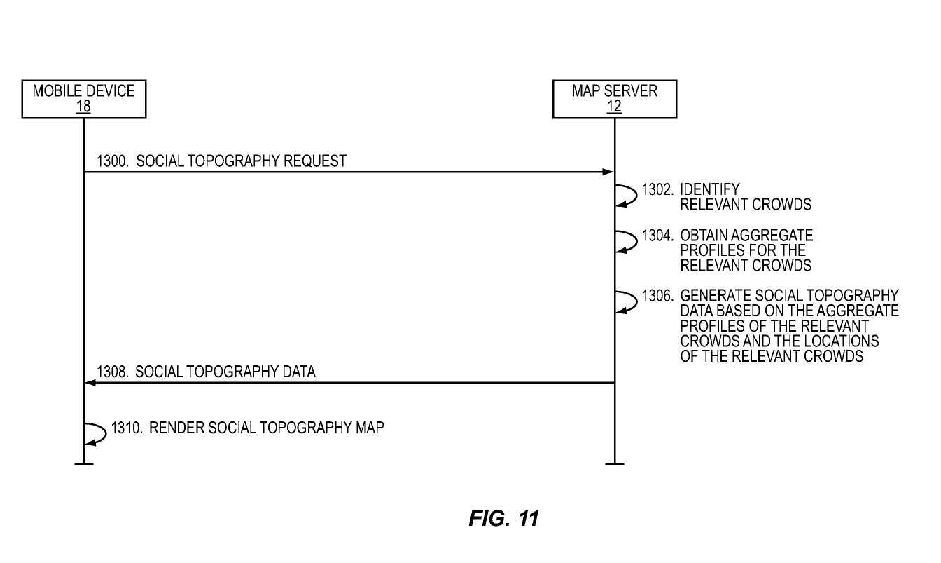

FIG. 11 illustrates the operation of the system 10 of FIG. 1 to generate a social topography map according to one embodiment of the present disclosure. In this embodiment, one of the mobile devices 18 sends a social topography request to the MAP server 12 (step 1300). More specifically, in this embodiment, the user 20 of the mobile device 18 initiates the social topography request via the MAP application 32 or one of the third-party applications 34. For example, a mapping application such as, for example, Google Maps may be configured to enable the user 20 to initiate the social topography request for a desired geographic area. The social topography request includes data that defines a bounding region for the social topography map. The data that defines the bounding region for the social topography map may include, for example, two or more locations (e.g., two or more latitude and longitude coordinate pairs or two or more street addresses) that define two or more corners of a rectangular bounding region, a location (e.g., a latitude and longitude coordinate pair or a street address) defining a center of a circular bounding region and a distance defining a radius of the circular bounding region, or the like.

Upon receiving the request, the social topography generator 60 of the MAP server 12 identifies crowds that are relevant to the bounding region for the social topography request, which are referred to herein as relevant crowds (step 1302). The relevant crowds are preferably crowds that are located within the bounding region or, in some embodiments, overlap the bounding region. More specifically, the relevant crowds may be crowds having crowd centers that are within the bounding region, crowds where all of the users in the crowds are currently located within the bounding region, crowds where at least one of the users in each of the crowds is currently located within the bounding region, crowds having a crowd boundary (e.g., a rectangular box defined by the most southwest user and most northeast user in the crowd) that is within or overlaps the bounding region, or the like.

The social topography generator 60 then interacts with the aggregation engine 58 to obtain aggregate profiles for the relevant crowds (step 1304). In one embodiment, for each relevant crowd, the aggregate profile of the relevant crowd is generated based on a comparison of the user profile (or a select subset thereof) of the user 20 of the mobile device 18, which is referred to herein as the requesting user, and the user profiles of the users 20 in the relevant crowd. As a result of the comparison, the aggregate profile of the relevant crowd preferably includes either a total number of user matches across the user profile of the requesting user (or a select subset of the user profile of the requesting user) or a number of user matches for each interest, or keyword, in the user profile of the requesting user (or a select subset thereof). The total number of user matches across the user profile of the requesting user is preferably a number of users in the relevant crowd that have user profiles that include at least one interest, or keyword, that matches an interest, or keyword, in the user profile of the requesting user. As used herein, “matching” interests may be interests that exactly match (i.e., exactly the same keywords) or interests that match at least to a predetermined threshold degree as determined via, for example, natural language processing, semantic analysis using, for example, an ontology defining relationships between terms, or the like. For example, NC State University may be determined to match NCSU even though it is not an exact match. Likewise, Tom O'Brien may be determined to match NCSU because he is sufficiently related to NCSU (e.g., within a predefined maximum degree of separation) in an ontology or similar data structure (e.g., directly related in Wikipedia). Similarly, the number of user matches for an interest in the user profile of the requesting user is a number of users in the relevant crowd that have user profiles that include an interest, or keyword, that matches the interest, or keyword, from the user profile of the requesting user.

In another embodiment, for each relevant crowd, the aggregate profile of the relevant crowd is generated based on a comparison of a target user profile defined by the user 20 of the mobile device 18 and the user profiles of the users in the relevant crowd. As a result of the comparison, the aggregate profile of the relevant crowd preferably includes either a total number of user matches across the target user profile or a number of user matches for each interest, or keyword, in the target user profile. The total number of user matches across the target user profile is preferably a number of users in the relevant crowd that have user profiles that include at least one interest, or keyword, that matches an interest, or keyword, in the target user profile. Similarly, the number of user matches for an interest in the target user profile is a number of users in the relevant crowd that have user profiles that include an interest, or keyword, that matches the interest, or keyword, from the target user profile.

Next, in this embodiment, the social topography generator 60 generates social topography data for the bounding region based on the aggregate profiles of the relevant crowds and the locations of the relevant crowds (step 1306). The social topography data includes data that defines concentrations of user affinity with either the requesting user or the target user profile, depending on the particular implementation, across the bounding region for the social topography map. In general, the social topography data includes user affinities for different sub-regions (e.g., grid locations) within the bounding region, which may be referred to herein as a user affinity distribution for the bounding region, and either numbers of users or numbers of crowds for different sub-regions within the bounding region, which may be referred to herein as user or crowd distribution for the bounding region. For a sub-region within the bounding region, the user affinity for the sub-region is determined based on the aggregate profiles of the crowds relevant to that sub-region (e.g., an average of the total number of user matches from the aggregate profiles of the crowds relevant to the sub-region or a weighted average of the number of user matches for individual interests from the aggregate profiles of the crowds relevant to the sub-region). Similarly, the number of users for the sub-region is the total number of users in the crowds relevant to the sub-region, and the number of crowds for the sub-region is the total number of crowds relevant to the sub-region.

The social topography generator 60 of the MAP server 12 then returns the social topography data generated in step 1306 to the mobile device 18 (step 1308). The mobile device 18 then renders a social topography map based on the social topography data received from the MAP server 12 (step 1310). The social topography map may be rendered by, for example, the MAP application 32 or one of the third-party applications 34 of the mobile device 18. Preferably, the social topography map is rendered as a 3D overlay that is overlaid upon a map of the corresponding bounding region similar to that illustrated above in FIG. 10. In one embodiment, the overlaid social topography is rendered as a transparent overlay over the map such that the underlying map is still visible to a degree. The user may be able to adjust the opacity level of the overlay. However, the social topography map may alternatively be rendered as a 2D overlay that is overlaid upon a map of the corresponding bounding region. Further, while the social topography map is preferably rendered as an overlay, the social topography map is not limited thereto. Before proceeding, it should be noted that while the MAP server 12 returns social topography data in the embodiment of FIG. 11, the present disclosure is not limited thereto. In another embodiment, the MAP server 12 may generate the social topography map based on the social topography data and return the social topography map to the mobile device 18 to be presented to the user 20.

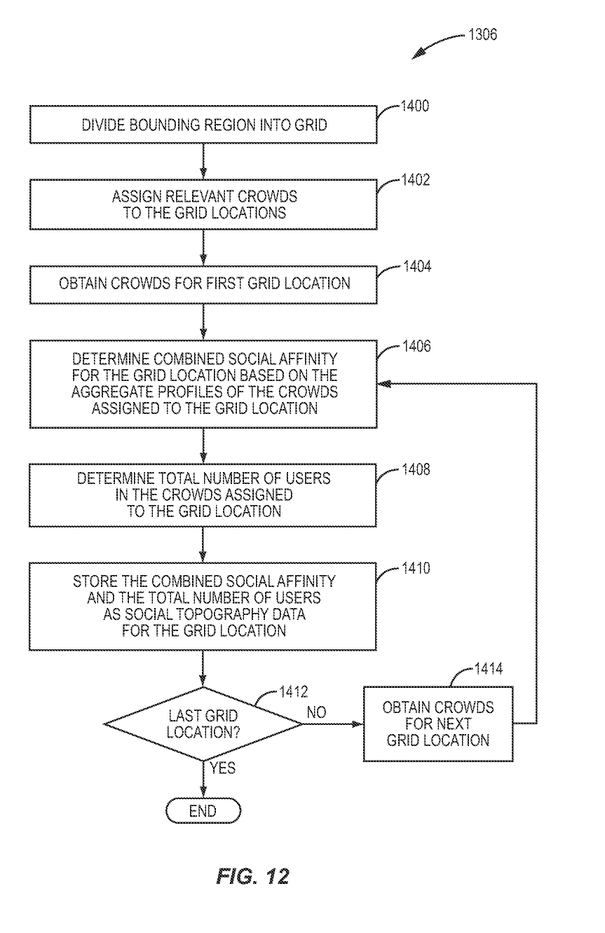

FIG. 12 illustrates step 1306 of FIG. 11 in more detail according to one embodiment of the present disclosure. First, in order to generate the social topography data for the bounding region of the social topography request, the social topography generator 60 of the MAP server 12 divides the bounding region into a grid (step 1400). Each grid location within the grid has as predetermined size, which may be static or may be a function of the size of the bounding region. Next, the social topography generator 60 assigns the relevant crowds to the appropriate grid locations within the bounding region (step 1402). Preferably, the size of the grid locations is substantially greater than the size of a typical crowd. In one embodiment, each of the relevant crowds is assigned to one of the grid locations. If a crowd overlaps two or more of the grid locations, the crowd may be assigned to one of the grid locations such as, for example, the grid location in which the crowd center of the crowd is located or the grid location in which a majority of the users in the crowd are located. In another embodiment, each relevant crowd is assigned to the grid location(s) in which the crowd is located or which the relevant crowd overlaps. If the relevant crowd overlaps two or more grid locations, then the relevant crowd is assigned to all of those grid locations.

Next, the social topography generator 60 obtains the crowds assigned to a first grid location in the grid (step 1404). Assuming that there are one or more crowds assigned to the grid location, the social topography generator 60 determines a combined user affinity for the grid location based on the aggregate profiles of the relevant crowds assigned to the grid location (step 1406). In one embodiment, the aggregate profile of each of the relevant crowds includes the total number of user matches for the relevant crowd over all of the interests, or keywords, in the user profile of the requesting user (or a select subset thereof) or the target user profile, depending on the particular implementation. In this case, the combined user affinity for the grid location may be a combination (e.g., an average) of the total number of user match values from the aggregate profiles of the relevant crowds assigned to the grid location. For example, the combined user affinity for the grid location may be computed as:

$$CombinedUserAffinity = \frac{{\sum }_{i = 1}^{m} {TotalNumberOfUserMatches}_{i}}{m} ,$$

where TotalNumberOfUserMatchesᵢ is the total number of user matches across all interests for the i^{th} relevant crowd assigned to the grid location and m is the number of relevant crowds assigned to the grid location.

In another embodiment, the aggregate profile of each of the relevant crowds includes a number of user matches for the crowd for each interest in the user profile of the requesting user (or a select subset thereof) or the target user profile, depending on the particular implementation. In this case, interests in the user profile of the requesting user or the target user profile may be assigned weights, and the combined user affinity for the grid location may be a weighted average of the number of user matches for all of the interests across all of the relevant crowds assigned to the grid location. The weights are preferably user-assigned weights that are included in the user profile of the requesting user or the target user profile, depending on the particular implementation. For example, the combined user affinity for the grid location may be computed as:

$$CombinedUserAffinity = \frac{{\sum }_{i = 1}^{m 1} \{ {w}_{i} \times ( \frac{{\sum }_{j = 1}^{m 2} {NumberOfUserMatches}_{i , j}}{m 2} ) \}}{{\sum }_{i = 1}^{m 1} {w}_{i}} ,$$

where NumberOfUserMatches_{i,j} is the number of user matches for the i^{th} interest for the j^{th} relevant crowd assigned to the grid location, wᵢ is the weight assigned to the i^{th} interest, m1 is the number of interests in the user profile of the requesting user (or a select subset thereof) or the target user profile, and m2 is the number of relevant crowds assigned to the grid location. Note that the examples given above for how to generate the combined user affinity for the grid location are exemplary rather than limiting. Any suitable technique may be used to generate a user affinity for the grid location based on the aggregate profiles of the relevant crowds assigned to the grid location or, more specifically, based on the user profiles of the users in the crowds assigned to the grid location and either the user profile of the requesting user or the target user profile, depending on the particular implementation.

In addition to determining the combined user affinity for the grid location, the social topography generator 60 determines a total number of users in the relevant crowds assigned to the grid location (step 1408). In other words, the social topography generator 60 determines the sum of the number of users in all of the relevant crowds assigned to the grid location. Note that step 1408 is not needed in some embodiments. Particularly, in some embodiments, the number of crowds assigned to the grid location is utilized for the social topography rather than the total number of users in the relevant crowds assigned to the grid location. In this case, the total number of users in the relevant crowds assigned to the grid location is not needed and, therefore, step 1408 can be omitted.

The combined user affinity and the total number of users in the relevant crowds assigned to the grid location are stored as the social topography data for the grid location (step 1410). Note that in some cases, there may be no relevant crowds assigned to a grid location. If so, steps 1404 through 1408 may be skipped, and, as an example, minimum values (e.g., 0) may be stored for both the combined user affinity and the total number of users or crowds for the grid location in step 1410.

Next, the social topography generator 60 determines whether the last grid location has been processed (step 1412). If not, the social topography generator 60 obtains the crowds assigned to the next grid location (step 1414) and then the process returns to step 1406 and is repeated for the next grid location. Once all of the grid locations have been processed, generation of the social topography for the bounding region of the social topography request is complete. In some embodiments, the generated topography data may be further processed so as to appear more visually appealing on rendering, such as by applying smoothing across or within grid locations to reduce sharp edges and blockiness. The user may be able to configure such processing to influence the rendering of the social topography data, for example, via the MAP application 32 running on the mobile device 18. Note that such smoothing may alternatively be performed when rendering the social topography map.

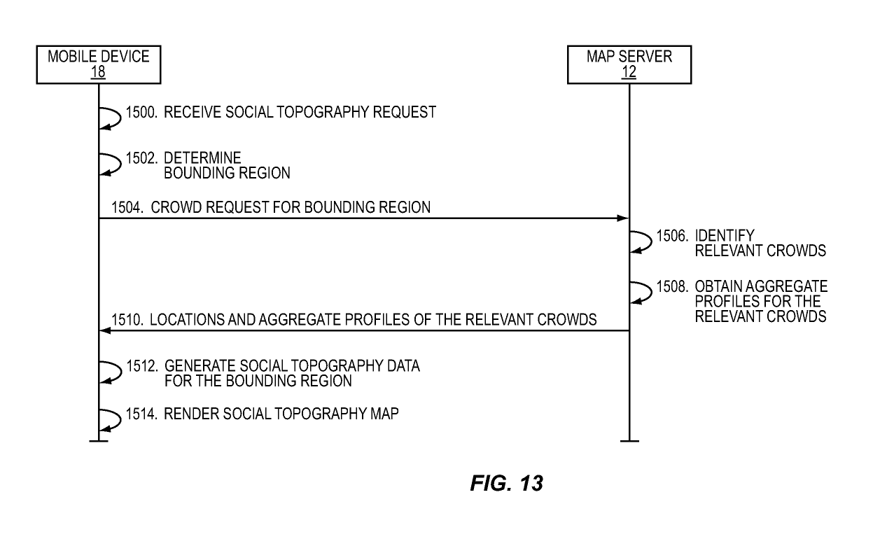

FIG. 13 illustrates the operation of the system 10 of FIG. 1 to generate a social topography map according to another embodiment of the present disclosure. This embodiment is similar to that described above with respect to FIGS. 11 and 12 but where the social topography data is generated at the mobile device 18 rather than the MAP server 12. In this embodiment, one of the mobile devices 18 receives a social topography request from its user 20 (step 1500) and determines a bounding region for the social topography request (step 1502). Preferably, the bounding region is selected by the user 20. For example, the user 20 may select the bounding region from a map.

The mobile device 18 then sends a crowd request for the bounding region to the MAP server 12 (step 1504). The crowd request includes information that defines the bounding region. The information that defines the bounding region may include, for example, two or more locations (e.g., two or more latitude and longitude coordinate pairs or two or more street addresses) that define two or more corners of a rectangular bounding region, a location (e.g., a latitude and longitude coordinate pair or a street address) defining a center of a circular bounding region and a distance defining a radius of the circular bounding region, or the like. In response to the crowd request, the MAP server 12 identifies crowds that are relevant to the bounding region, which are referred to herein as relevant crowds (step 1506). The relevant crowds are preferably crowds that are located within the bounding region or, in some embodiments, overlap the bounding region. More specifically, the relevant crowds may be crowds having crowd centers that are within the bounding region, crowds where all of the users in the crowds are currently located within the bounding region, crowds where at least one of the users in each of the crowds is currently located within the bounding region, crowds having a crowd boundary (e.g., a rectangular box defined by the most southwest user and most northeast user in the crowd) that is within or overlaps the bounding region, or the like.

The MAP server 12 utilizes the aggregation engine 58 to obtain aggregate profiles for the relevant crowds (step 1508). In one embodiment, for each relevant crowd, the aggregate profile of the relevant crowd is generated based on a comparison of the user profile (or a select subset thereof) of the user 20 of the mobile device 18, which is referred to herein as the requesting user and the user profiles of the users 20 in the relevant crowd. As a result of the comparison, the aggregate profile of the relevant crowd preferably includes either a total number of user matches across the user profile of the requesting user (or a select subset of the user profile of the requesting user) or a number of user matches for each interest, or keyword, in the user profile of the requesting user (or a select subset thereof). In another embodiment, for each relevant crowd, the aggregate profile of the relevant crowd is generated based on a comparison of a target user profile defined by the user 20 of the mobile device 18 and the user profiles of the users in the relevant crowd. As a result of the comparison, the aggregate profile of the relevant crowd preferably includes either a total number of user matches across the target user profile or a number of user matches for each interest, or keyword, in the target user profile.

Next, in this embodiment, the MAP server 12 returns the locations of the relevant crowds and the aggregate profiles of the relevant crowds to the mobile device 18 (step 1510). The mobile device 18 then generates social topography data for the bounding region based on the aggregate profiles of the relevant crowds and the locations of the relevant crowds (step 1512). The social topography data may, for example, be generated by the MAP application 32 or one of the third-party applications 34 that received the social topography request in step 1500. The social topography data includes data that defines concentrations of user affinity with either the requesting user or the target user profile, depending on the particular implementation, across the bounding region for the social topography map. In general, the social topography data includes user affinities for different sub-regions (e.g., grid locations) within the bounding region, which may be referred to herein as a user affinity distribution for the bounding region, and either a number of users or a number of crowds for different sub-regions within the bounding region, which may be referred to herein as user or crowd distribution for the bounding region. For a sub-region within the bounding region, the user affinity for the sub-region is determined based on the aggregate profiles of the crowds relevant to that sub-region (e.g., an average of the total number of user matches from the aggregate profiles of the crowds relevant to the sub-region or a weighted average of the number of user matches for individual interests from the aggregate profiles of the crowds relevant to the sub-region). Similarly, the number of users for the sub-region is the total number of users in the crowds relevant to the sub-region, and the number of crowds for the sub-region is the total number of crowds relevant to the sub-region. In one embodiment, the social topography is generated using the process of FIG. 12.

The mobile device 18 then renders a social topography map based on the social topography data generated in step 1512 (step 1514). The social topography map may be rendered by, for example, the MAP application 32 or one of the third-party applications 34 of the mobile device 18. Preferably, the social topography map is rendered as a 3D overlay that is overlaid upon a map of the corresponding bounding region similar to that illustrated above in FIG. 10. However, the social topography map may alternatively be rendered as a 2D overlay that is overlaid upon a map of the corresponding bounding region. Further, while the social topography map is preferably rendered as an overlay, the social topography map is not limited thereto.

It should be noted that while FIGS. 11 through 13 describe serving social topography requests for the mobile device 18, social topography requests may also be served for the subscriber device 22 and/or the third-party service 26 in the same or similar manner. Specifically, the MAP server 12 may receive a social topography request from the subscriber device 22 and return either social topography data or a social topography map to the subscriber device 22 in response to the social topography request. In a similar manner, the subscriber device 22 may include an application that requests crowd data from the MAP server 12 and generates a social topography map based on the crowd data in a manner similar to that described above with respect to FIG. 13. The MAP server 12 may additionally or alternatively receive social topography requests from the third-party service 26 and return either social topography data or social topography maps to the third-party service 26. For example, a web-based map service such as Google Maps may utilize the MAP server 12 to obtain social topography data in order to render social topography map overlays on their existing maps as desired by their users. Similarly, the third-party service 26 may request crowd data from the MAP server 12 and generate social topography maps based on the crowd data in a manner similar to that described above with respect to FIG. 13.

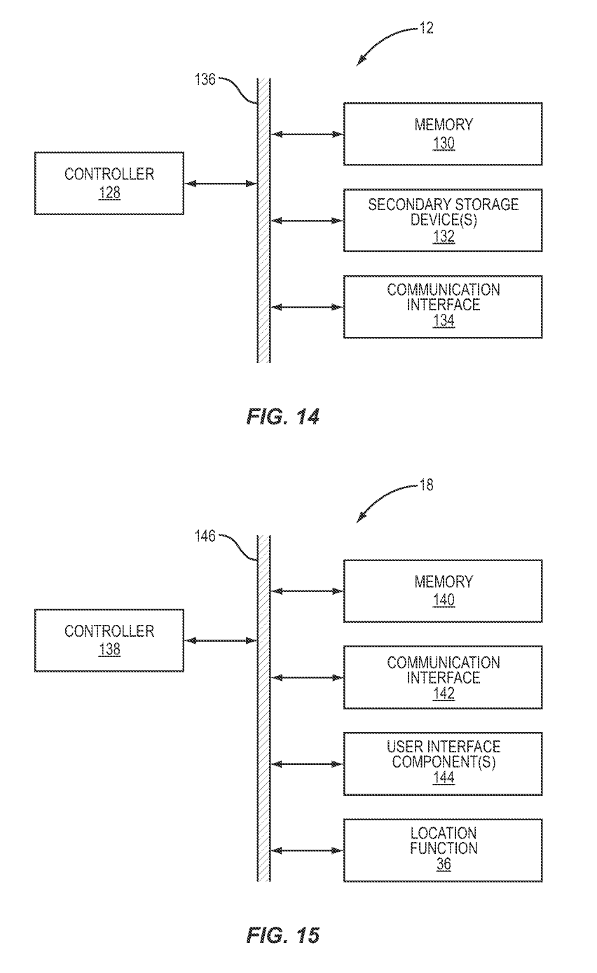

FIG. 14 is a block diagram of the MAP server 12 according to one embodiment of the present disclosure. As illustrated, the MAP server 12 includes a controller 128 connected to memory 130, one or more secondary storage devices 132, and a communication interface 134 by a bus 136 or similar mechanism. The controller 128 is a microprocessor, digital Application Specific Integrated Circuit (ASIC), Field Programmable Gate Array (FPGA), or the like. In this embodiment, the controller 128 is a microprocessor, and the application layer 40, the business logic layer 42, and the object mapping layer 62 (FIG. 2) are implemented in software and stored in the memory 130 for execution by the controller 128. Further, the datastore 64 (FIG. 2) may be implemented in the one or more secondary storage devices 132. The secondary storage devices 132 are digital data storage devices such as, for example, one or more hard disk drives. The communication interface 134 is a wired or wireless communication interface that communicatively couples the MAP server 12 to the network 28 (FIG. 1). For example, the communication interface 134 may be an Ethernet interface, local wireless interface such as a wireless interface operating according to one of the suite of IEEE 802.11 standards, or the like.

FIG. 15 is a block diagram of one of the mobile devices 18 according to one embodiment of the present disclosure. As illustrated, the mobile device 18 includes a controller 138 connected to memory 140, a communication interface 142, one or more user interface components 144, and the location function 36 by a bus 146 or similar mechanism. The controller 138 is a microprocessor, digital ASIC, FPGA, or the like. In this embodiment, the controller 138 is a microprocessor, and the MAP client 30, the MAP application 32, and the third-party applications 34 are implemented in software and stored in the memory 140 for execution by the controller 138. In this embodiment, the location function 36 is a hardware component such as, for example, a GPS receiver. The communication interface 142 is a wireless communication interface that communicatively couples the mobile device 18 to the network 28 (FIG. 1). For example, the communication interface 142 may be a local wireless interface such as a wireless interface operating according to one of the suite of IEEE 802.11 standards, a mobile communications interface such as a cellular telecommunications interface, or the like. The one or more user interface components 144 include, for example, a touchscreen, a display, one or more user input components (e.g., a keypad), a speaker, or the like, or any combination thereof.

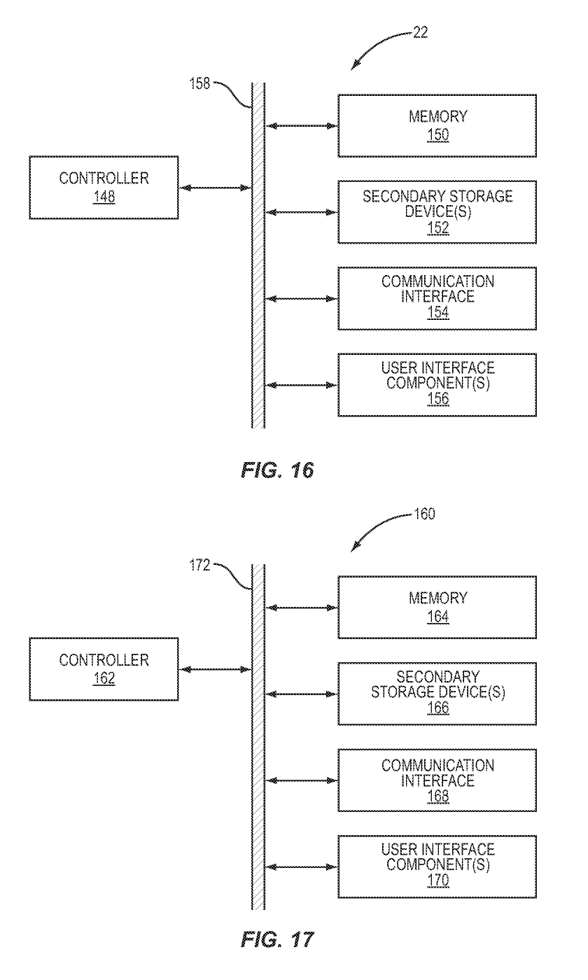

FIG. 16 is a block diagram of the subscriber device 22 according to one embodiment of the present disclosure. As illustrated, the subscriber device 22 includes a controller 148 connected to memory 150, one or more secondary storage devices 152, a communication interface 154, and one or more user interface components 156 by a bus 158 or similar mechanism. The controller 148 is a microprocessor, digital ASIC, FPGA, or the like. In this embodiment, the controller 148 is a microprocessor, and the web browser 38 (FIG. 1) is implemented in software and stored in the memory 150 for execution by the controller 148. The one or more secondary storage devices 152 are digital storage devices such as, for example, one or more hard disk drives. The communication interface 154 is a wired or wireless communication interface that communicatively couples the subscriber device 22 to the network 28 (FIG. 1). For example, the communication interface 154 may be an Ethernet interface, local wireless interface such as a wireless interface operating according to one of the suite of IEEE 802.11 standards, a mobile communications interface such as a cellular telecommunications interface, or the like. The one or more user interface components 156 include, for example, a touchscreen, a display, one or more user input components (e.g., a keypad), a speaker, or the like, or any combination thereof.

FIG. 17 is a block diagram of a computing device 160 operating to host the third-party service 26 according to one embodiment of the present disclosure. The computing device 160 may be, for example, a physical server. As illustrated, the computing device 160 includes a controller 162 connected to memory 164, one or more secondary storage devices 166, a communication interface 168, and one or more user interface components 170 by a bus 172 or similar mechanism. The controller 162 is a microprocessor, digital ASIC, FPGA, or the like. In this embodiment, the controller 162 is a microprocessor, and the third-party service 26 is implemented in software and stored in the memory 164 for execution by the controller 162. The one or more secondary storage devices 166 are digital storage devices such as, for example, one or more hard disk drives. The communication interface 168 is a wired or wireless communication interface that communicatively couples the computing device 160 to the network 28 (FIG. 1). For example, the communication interface 168 may be an Ethernet interface, local wireless interface such as a wireless interface operating according to one of the suite of IEEE 802.11 standards, a mobile communications interface such as a cellular telecommunications interface, or the like. The one or more user interface components 170 include, for example, a touchscreen, a display, one or more user input components (e.g., a keypad), a speaker, or the like, or any combination thereof.

Those skilled in the art will recognize improvements and modifications to the preferred embodiments of the present disclosure. All such improvements and modifications are considered within the scope of the concepts disclosed herein and the claims that follow.

What is claimed is:

1. A computer-implemented method comprising:
obtaining a plurality of aggregate profiles for a plurality of crowds that are relevant to a desired geographic bounding region, wherein each aggregate profile of the plurality of aggregate profiles is an aggregate profile of a corresponding one of the plurality of crowds and includes information regarding a user affinity between the corresponding one of the plurality of crowds and a defined user profile; and
generating social topography data for the desired geographic bounding region based on the plurality of aggregate profiles and locations of the plurality of crowds, wherein the social topography data defines user affinity concentrations across the desired geographic bounding region.

2. The method of claim 1 wherein generating the social topography data for the desired geographic bounding region comprises generating data that represents a user affinity distribution for the desired geographic bounding region.

3. The method of claim 2 wherein generating the data that represents the user affinity distribution for the desired geographic bounding region comprises, for each sub-region of at least a subset of a plurality of sub-regions within the desired geographic bounding region, determining a combined user affinity for the sub-region based on the aggregate profiles of one or more crowds of the plurality of crowds that are relevant to the sub-region.

4. The method of claim 2 wherein generating the social topography data for the desired geographic bounding region further comprises generating data that represents a user distribution for the desired geographic bounding region.

5. The method of claim 4 wherein generating the data that represents the user distribution for the desired geographic bounding region comprises, for each sub-region of at least a subset of a plurality of sub-regions within the desired geographic bounding region, determining a total number of users in one or more crowds of the plurality of crowds that are relevant to the sub-region.

6. The method of claim 2 wherein generating the social topography data for the desired geographic bounding region further comprises generating data that represents a crowd distribution for the desired geographic bounding region.

7. The method of claim 6 wherein generating the data that represents the crowd distribution for the desired geographic bounding region comprises, for each sub-region of at least a subset of a plurality of sub-regions within the desired geographic bounding region, determining a total number of crowds from the plurality of crowds that are relevant to the sub-region.

8. The method of claim 1 wherein generating the social topography data for the desired geographic bounding region comprises:
dividing the desired geographic bounding region into a plurality of sub-regions;
assigning the plurality of crowds to the plurality of sub-regions; and
for each sub-region of the plurality of sub-regions:
determining a combined user affinity for the sub-region based on the aggregate profiles of one or more crowds of the plurality of crowds that are assigned to the sub-region; and
determining at least one of a group consisting of: a total number of users in the one or more crowds assigned to the sub-region and a total number of crowds assigned to the sub-region;
wherein the social topography data for the desired geographic bounding region comprises, for each sub-region of the plurality of sub-regions, the combined user affinity for the sub-region and at least one of the group consisting of: the total number of users in the one or more crowds assigned to the sub-region and the total number of crowds assigned to the sub-region.

9. The method of claim 1 further comprising providing a social topography map based on the social topography data generated for the desired geographic bounding region.

10. The method of claim 9 wherein the social topography map is a 3-dimensional (3D) social topography map.

11. The method of claim 10 wherein a height dimension of the 3D social topography map is representative of user concentrations and a second characteristic of the 3D social topography map is representative of user affinity.

12. The method of claim 10 wherein a height dimension of the 3D social topography map is representative of user affinity and a second characteristic of the 3D social topography map is representative of user concentrations.

13. The method of claim 10 wherein the 3D social topography map is an overlay that is overlaid upon a map of the desired geographic bounding region.

14. The method of claim 10 wherein the 3D social topography map is enabled to be manipulated by a user.

15. The method of claim 9 wherein the social topography map is a 2-dimensional (2D) social topography map.

16. A computing device comprising:
a communication interface; and
a controller associated with the communication interface and adapted to:
obtain a plurality of aggregate profiles for a plurality of crowds that are relevant to a desired geographic bounding region, wherein each aggregate profile of the plurality of aggregate profiles is an aggregate profile of a corresponding one of the plurality of crowds and includes information regarding a user affinity between the corresponding one of the plurality of crowds and a defined user profile; and
generate social topography data for the desired geographic bounding region based on the plurality of aggregate profiles and locations of the plurality of crowds, wherein the social topography data defines user affinity concentrations across the desired geographic bounding region.

17. The computing device of claim 16 wherein the computing device is a server, and the controller is further adapted to:
receive a social topography request for the desired geographic bounding region from a requesting device over a network via the communication interface;
generate the social topography data for the desired geographic bounding region in response to the social topography request; and
return the social topography data to the requesting device over the network via the communication interface.

18. The computing device of claim 16 wherein the controller is further adapted to:
send a crowd request to a remote server over a network via the communication interface;
receive, in response to the crowd request, the plurality of aggregate profiles and the locations of the plurality of crowds from the remote server over the network via the communication interface; and
generate the social topography data for the desired geographic bounding region in response to receiving the plurality of aggregate profiles and the locations of the plurality of crowds from the remote server.

19. The computing device of claim 18 wherein the controller is further adapted to render a social topography map for the desired geographic bounding region for presentation to an associated user based on the social topography data generated for the desired geographic bounding region.

20. A non-transitory computer-readable medium storing software comprising instructions for instructing a controller of a computing device to:
obtain a plurality of aggregate profiles for a plurality of crowds that are relevant to a desired geographic bounding region, wherein each aggregate profile of the plurality of aggregate profiles is an aggregate profile of a corresponding one of the plurality of crowds and includes information regarding a user affinity between the corresponding one of the plurality of crowds and a defined user profile; and
generate social topography data for the desired geographic bounding region based on the plurality of aggregate profiles and locations of the plurality of crowds, wherein the social topography data defines user affinity concentrations across the desired geographic bounding region.
